(19) United States
(12) Patent Application Publication
(10) Pub. No.: US 2025/0199315 A1
(43) Pub. Date: Jun. 19, 2025

(54) ARTIFICIAL-REALITY GLASSES WITH A RIGID UNIBODY MEMBER, AND SYSTEMS AND METHODS OF USE THEREOF

(71) Applicant: Meta Platforms Technologies, LLC, Menlo Park, CA (US)

(72) Inventors: Helia Rahmani, Mountain View, CA (US); Kirk Erik Burgess, Newark, CA (US); Michiel Koen Callens, Mountain View, CA (US); Saara Khan, Cupertino, CA (US); Igor Markovsky, Campbell, CA (US)

(21) Appl. No.: 18/972,722

(22) Filed: Dec. 6, 2024

Related U.S. Application Data
(60) Provisional application No. 63/612,310, filed on Dec. 19, 2023.

(51) Int. Cl. G02B 27/01; G02C 1/00

(52) U.S. Cl. CPC G02B 27/0172; G02B 27/0101; G02C 1/00; G02B 2027/0138; G02B 2027/014; G02B 2027/0178

(57) ABSTRACT

A pair of artificial-reality glasses that comprise a deformable frame, a rigid unibody member (distinct from the deformable frame and configured to couple to the deformable frame), a first lens assembly (coupled to a first portion of the rigid unibody member) and a second lens assembly (coupled to a second portion of the rigid unibody member at a predefined relative position to the first lens assembly), depth sensors, force sensors, and processors. A nose bridge portion of the rigid unibody member includes structure reinforcements. The force sensors detect deformation of the rigid unibody member such that the second lens assembly is not at the predefined position relative to the first lens assembly. The processors receive deformation data from the one or more force sensors and cause the artificial-reality glasses to apply a disparity correction to the first lens assembly and the second lens assembly.

### CROSS-REFERENCE TO RELATED APPLICATIONS

This application claims priority to U.S. Prov. Patent App. No. 63/612,310, filed Dec. 19, 2023, entitled “Artificial-Reality Glasses with a Rigid Unibody Member, and Systems and Methods of Use Thereof,” which is hereby fully incorporated by reference in its entirety.

### TECHNICAL FIELD

This relates generally to artificial-reality glasses, including but not limited to techniques for reducing binocular disparity (e.g., a difference in image location of an object seen by the left and right eyes) caused by misalignment of lens assemblies of the artificial-reality glasses by mounting the lens assemblies on a rigid frame that is distinct from a less rigid glasses-frame.

### BACKGROUND

Users of artificial-reality glasses can become substantially immersed in the artificial-reality environment, which can be conducive to a richer, more engaging user experience. However, one drawback to displaying an artificial-reality environment using two independent display devices is that the two display devices can become misaligned. The misalignment can cause binocular disparity. In some cases, binocular disparity can cause the image quality of the artificial-reality environment to be negatively impacted. For example, the images may be perceived by the user as blurry and/or the user may see the images in double vision. Moreover, binocular disparity can lead to the user of the artificial-reality glasses experiencing physical discomfort (e.g., eyestrain and/or headaches).

Techniques for increasing rigidity of artificial-reality glasses exist but traditionally result in heavy, bulky, and/or cumbersome artificial-reality glasses that are unable to decouple load transfer from the rigid frame structure to the artificial-reality display components of the artificial-reality glasses. In addition, traditional artificial-reality glasses that are not heavy, bulky, and/or cumbersome are insufficiently rigid to prevent binocular disparity such that a user has a pleasant experience. Accordingly, there is a need to increase the rigidity of artificial-reality glasses while minimizing load transfer to the display components to ensure that the user experience with respect to the image quality, weight, bulk, and/or overall physical comfort is enjoyable.

As such, there is a need to address one or more of the above-identified challenges. A brief summary of solutions to the issues noted above are described below.

### SUMMARY

The methods, systems, and devices described herein allow users wearing artificial-reality glasses to experience fewer, or less intense, binocular disparities by increasing a rigidity of a frame and minimizing load transfer to the display devices during the use and/or handling of the artificial-reality glasses. A rigid unibody member (e.g., a rigid optomechanical bench) is integrated and/or coupled with a deformable frame. The rigid unibody member increases the structural rigidity of the artificial-reality glasses such that binocular disparities are reduced. The deformable frame surrounds the rigid unibody member to decouple load transfer to the display devices and increase a user's physical comfort while wearing the artificial-reality glasses with the rigid unibody member.

Furthermore, the artificial-reality glasses are configured to perform active and/or online disparity correction. For example, active and/or online disparity correction includes adjusting one or more optical components (e.g., lens, collimation optics, etc.) of a display projector assembly of the artificial-reality glasses. The disparity correction is based on deformation data that is received by one or more force sensors (e.g., strain sensors, stress sensors, strain gauges, stress gauges, etc.) coupled to the artificial-reality glasses. Combining the rigid unibody member with the disparity correction can further reduce the amount of disparity (e.g., binocular disparity, optical disparity, mechanical disparity, etc.) experienced by the user.

One example of artificial-reality glasses is described herein. This example artificial-reality glasses includes a deformable frame and a rigid unibody member. The rigid unibody member is distinct and separate from the deformable frame. The rigid unibody member includes a nose bridge portion that includes structure reinforcements. Coupled to the rigid unibody member are a first lens assembly and a second lens assembly. The first lens assembly is coupled to a first portion of the rigid unibody member. The second lens assembly is coupled to a second portion of the rigid unibody member. The second portion is located at a predefined position relative to the first lens assembly. Also coupled to the rigid unibody member are one or more depth sensors and/or one or more force sensors. The one or more force sensors are configured to detect deformation of the rigid unibody member. Deformation of the rigid body includes the second lens assembly being not at the predefined position relative to the first lens assembly (e.g., a relative position distinct from the predefined position). At least one of the one or more force sensors is coupled with and/or located proximate to the nose bridge portion of the rigid unibody member.

The artificial-reality glasses further include one or more processors coupled with the deformable frame. The one or more processors are configured to receive deformation data from the one or more force sensors and/or the one or more depth sensors. The one or more processors are further configured to determine, based on the deformation data, that an amount of disparity between the first lens assembly and the second lens assembly satisfies calibration criteria. In accordance with the aforementioned determination, the one or more processors are further configured to cause the artificial-reality glasses to apply, based on the amount of disparity, a disparity correction to the first lens assembly and/or the second lens assembly.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C illustrate examples of artificial-reality glasses including a rigid unibody member, in accordance with some embodiments.

FIGS. 2A-2D illustrate an example of artificial-reality glasses in various thermal loading scenarios, in accordance with some embodiments.

FIGS. 3A and 3B illustrate examples of mechanical loads that can be experienced by artificial-reality glasses, in accordance with some embodiments.

FIGS. 4A and 4B illustrate an impact force experienced by artificial-reality glasses, in accordance with some embodiments.

FIG. 5 shows an example method flow chart for correcting disparity at artificial-reality glasses, in accordance with some embodiments.

FIG. 6 illustrate example artificial-reality systems, in accordance with some embodiments.

FIGS. 7A-7C illustrate example head-wearable devices, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

In accordance with some embodiments, systems, methods, and devices are described that provide for a rigid unibody optical bench that is attached to a deformable frame for artificial-reality glasses. The rigid unibody optical bench ensures an optically-aligned integration of one or more display engines with at least one display assembly and/or waveguiding lens that is resistant to donning-related mechanical deformations in the frame. The prevention of mechanical deformations of the frame reduces sources of optical disparity in the artificial-reality glasses system significantly lessening the need for complex disparity correction methods and improving a field-of-view of the display by reducing a number of border display pixels that would otherwise be allocated for implementation of disparity correction. In some embodiments, the use of the rigid unbody optical bench coupled to a light-weight deformable frame ensures improved integrity of optical alignments and component mechanical alignments within the artificial-reality glasses system while allowing the use of a deformable (e.g., less stiff) outer frame that can be manufactured out of lighter-weight materials to provide a more user-friendly experience (e.g., by reducing wear-fatigue).

In some embodiments, sources of optical disparity include misalignment and angular deformation between a display projector (e.g., display engine) and a waveguide (e.g., lens assembly), misalignment and angular deformation between the waveguide and a virtual image distance (VID) lens, misalignment between a left waveguide assembly and a right waveguide assembly and/or angular deformation between the left waveguide assembly and the right waveguide assembly. The rigid unibody optical bench can minimize the sources of optical disparity by creating a unibody system where all the alignment-sensitive components, and/or sensor systems are mounted on a rigid structure and in fixed positions relative to one-another.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

The systems and methods described herein increase the rigidity of the artificial-reality glasses via a rigid unibody member. As described herein, a rigid unibody member increases the rigidity of the artificial-reality glasses. Additionally, the systems and methods described herein use a deformable frame such that user comfort while wearing the artificial-reality glasses is not negatively impacted. Further, the systems and methods described herein allow for (1) detecting deformation data via one or more force sensors; (2) determining, based on the deformation data, whether calibration criteria is satisfied; and (3) causing the artificial-reality glasses to apply, based on the amount of disparity, a disparity correction to the artificial-reality glasses.

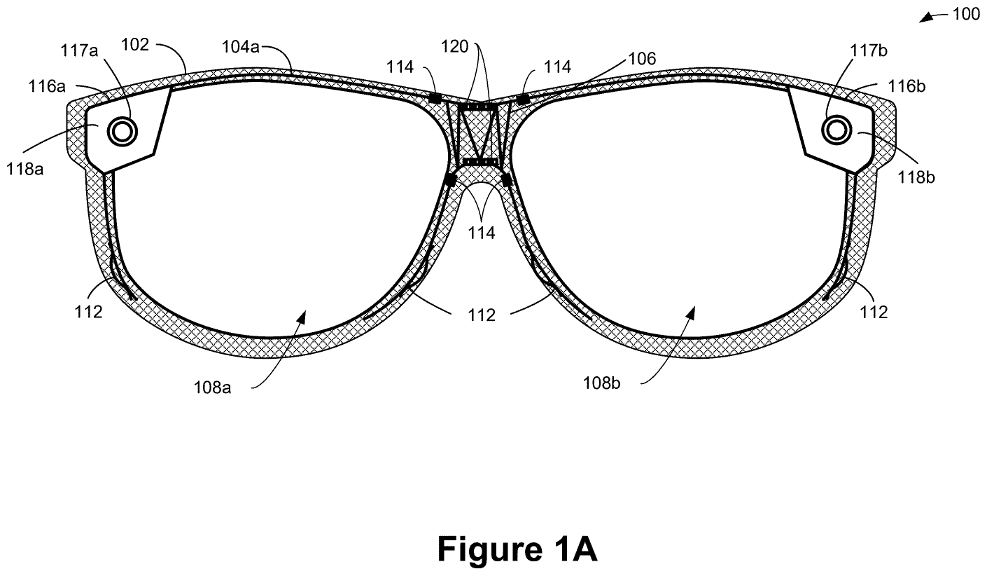

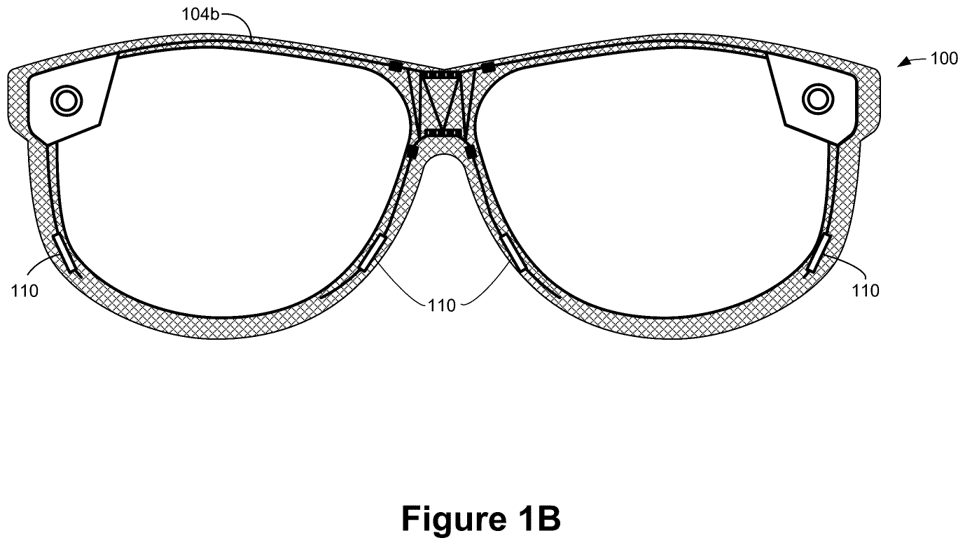

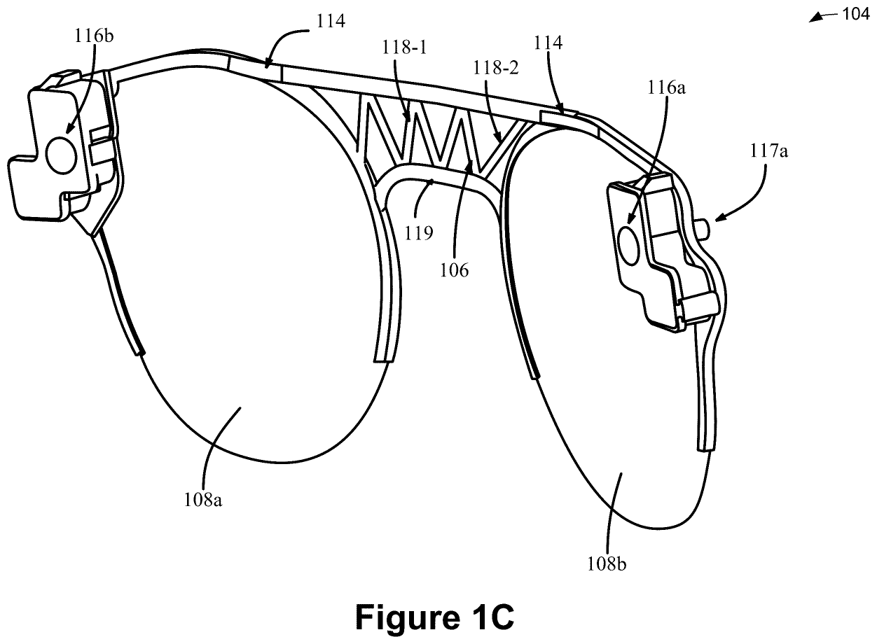

FIGS. 1A-1C illustrate examples of artificial-reality glasses 100 including a rigid unibody member, in accordance with some embodiments. The rigid unibody member 104 (e.g., a rigid optomechanical bench) is included within the artificial-reality glasses 100 and is substantially decoupled from the artificial-reality glasses 100 (e.g., frames or a deformable frame 102 of the artificial-reality glasses 100). Specifically, the rigid unibody member 104 is distinct and separate from the deformable frame 102 and partially coupled with the deformable frame 102 via one or more frame mounts 120. In some embodiments, the rigid unibody member 104 is fabricated out of metal matrix composites, metal additive manufacturing materials, and/or other materials that provide high stiffness with less mass or volume. In some embodiments, the deformable frame 102 is fabricated out of one or more materials that has a low frame stiffness (e.g., plastics, nylon, composites, etc.).

Additionally, the rigid unibody member 104 is configured to couple with one or more display assemblies (e.g., display projector assemblies 118, etc.), one or more lens assemblies 108 (e.g., optical waveguides, optical gratings, etc.), and substantially decouple the one or more display assemblies and the one or more lens assemblies from the deformable frame 102 (e.g., via one or more fixtures 112, one or more frame mounts 120, and/or adhesives 110) in order to minimize mechanical loads transferred to the display assemblies. Each of the above components are described in detail blow.

FIG. 1A illustrates a first example of a rigid unibody member 104a included in the artificial-reality glasses 100, in accordance with some embodiments. The first example rigid unibody member 104a includes and/or is coupled with one or more display assemblies, one or more lens assemblies, one or more flexures 112, one or more adhesives 110 (e.g., liquid, foam adhesives, etc.), one or more force sensors 114, and/or one or more frame mounts 120 to form a unified display assembly with calibration and disparity correction capabilities. In some embodiments, the rigid unibody member 104a is configured to couple a right lens assembly 108a with a left lens assembly 108b to maintain optical alignment between the right and left assemblies. In some embodiments, the rigid unibody member 104a is configured to align a right display engine 118a with a left display engine 118b to maintain optical alignment between the right and left display engines. In some embodiments, the rigid unibody member 104a is configured to align the right lens assembly 108a with the left lens assembly 108b and the right display engine 118a with the left display engine 118b to ensure optical alignment is maintained for optimum synchronized artificial-reality displays for both eyes.

Additionally, or alternatively, the rigid unibody member 104a is configured to couple (and/or align) each display assembly with the respective lens assembly without directly causing mechanical load transfer from the relatively heavier display assemblies 118 to the lens assemblies 108. In some embodiments, the rigid unibody member 104a is configured to prevent direct mechanical load transfer or impact transfer from the heavier display assemblies 118 to their respective lens assemblies 108. In some embodiments, a rigidity of the rigid unibody member 104a is configured to prevent load and stress related hot spots and failures.

The first example rigid unibody member 104a is formed of a stiff material with a low coefficient of thermal expansion (CTE). In particular, the first example rigid unibody member 104a is configured to have a CTE substantially equal to the CTE of the materials associated with the one or more coupled lens assemblies (e.g., waveguides of the lens assemblies). In some embodiments, the waveguides of the lens assemblies are fabricated of a material with a low CTE (e.g., titanium, silica, glass, calcium fluoride, optical polymer composites, etc.). In some embodiments, the first example rigid unibody member 104a is fabricated out of titanium, carbon fiber, and/or a magnesium alloy with a CTE that is similar to the CTE of the materials associated with the one or more coupled display assemblies (e.g., display projector, display engine, lenses, etc.). In some embodiments, the first example rigid unibody member 104a is fabricated out of metal matrix composites and/or metal additive composites that have a CTE that is similar to the CTE of the materials associated with the one or more coupled display assemblies. The materials for fabricating the rigid unibody member 104a are chosen based on optimizing all of the parameters including the CTE, stiffness, and weight to provide the most user-friendly experience.

The frame mounts 120 are configured to partially couple the first example rigid unibody member 104a to the deformable frame 102. The frame mounts 120 can be proximate to a nose portion of the first example rigid unibody member 104a (e.g., a portion of the artificial-reality glasses 100 that rest on a user's nose bridge). The frame mounts 120 are configured to reduce mechanical loads transferred from the deformable frame 102 to the rigid unibody member, as well as reduce deformation of the deformable frame 102 induced thermally (e.g., increased temperatures caused by operation of the display assemblies). For example, the frame mounts 120 reduce the mechanical loads associated with a bending force at the deformable frame 102 when donned by a user and adjusted for their head, or when the artificial-reality glasses 100 are dropped. Additionally, the frame mounts 120 are configured to reduce or eliminate thermal induced deformations (e.g., deformations of the artificial-reality glasses 100 due to increased temperatures caused by operations of one or more components of the artificial-reality glasses 100).

The nose portion of the first example rigid unibody member 104a includes a plurality of structure reinforcements 106 (and/or ribs) to increase the rigidity of the first example rigid unibody member 104a along the nose portion (e.g., in proximity to the user's nose bridge) of the first example rigid unibody member 104a. The plurality of structure reinforcements 106 further strengthen the nose portion of the first example rigid unibody member 104a, which can be a portion of the artificial-reality glasses 100 that is likely to deform because it is likely to have the largest mechanical stress applied (e.g., from an increased bending stress, torsional stress, shear stress, etc.) as a user interacts with the temple arms of the artificial-reality glasses 100. Additional mechanical stress applied to the artificial-reality glasses 100 can be a result of user actions that generate a bending and/or twisting motion to the artificial-reality glasses 100. The increased rigidity provided by the plurality of structure reinforcements 106 in proximity to the frame mounts 120 decreases the likelihood of deformation by decoupling the stresses and/or strains experienced by the deformable frame 102 from the first example rigid unibody member 104a.

In some embodiments, the plurality of structure reinforcements 106 (and/or ribs) are configured to minimize thermally induced deformations. For example, the plurality of structure reinforcements 106 are configured to minimize thermally induced deformations of the rigid unibody member 104a arising from one or more CTE mismatches corresponding to the materials used to fabricate the display assemblies, the lens assemblies, the depth sensors, and/or the one or more force sensors. In some embodiments, the depth sensors and/or the one or more force sensors are positioned and/or affixed to the rigid unibody member 104a instead of an outer frame of the artificial-reality glasses 100. In some embodiments, the plurality of structure reinforcements 106 (and/or ribs) are configured to increase a stiffness of the rigid unibody member while minimizing an increase in weight. In some embodiments, the plurality of structure reinforcements 106 include a step (e.g., 119) around the nose bridge and/or additional ribs (e.g., 118-1, 118-2, etc.) that reduce deformation concentrations around the nose bridge portion of the outer frame, deformable frame 102 and/or the rigid unibody frame 104.

The first example rigid unibody member 104a includes one or more flextures 112 (and/or foam adhesives 110; FIG. 1B) to decouple the display assemblies from the deformable frame 102. More specifically, the flexures 112 of the first example rigid unibody member 104a contact portions of the deformable frame 102 to allow the first example rigid unibody member 104a to be distinct and separate from the deformable frame 102. The flexures 112 are configured to reduce mechanical loads transferred from the deformable frame 102 to the first example rigid unibody member 104a, the display assemblies, and/or components thereof. For example, the flexures 112 can reduce mechanical loads transferred from the deformable frame 102 to the first lens assembly 108a and/or the second lens assembly 108b when the deformable frame 102 experiences a destructive load (e.g., a drop) and/or user applied loads (e.g., during adjustment of a size of the artificial-reality glasses 100). In other words, the flexures 112 can dampen or reduce force transfer from the deformable frame 102 to the first example rigid unibody member 104a, the display assemblies, and/or components thereof such that destructive loads are not fully transmitted to the first example rigid unibody member 104a, the display assemblies, and/or components thereof. In some embodiments, the flexures 112 are configured to reduce the mechanical loads transferred by a predetermined amount (e.g., at least 70%, 80%, 90%, etc.). The flexures 112 can be used alone or in conjunction with the foam adhesives 110 discussed below in reference to FIG. 1B.

The force sensors 114 are coupled to the first example rigid unibody member 104a. In some embodiments, the one or more force sensors 114 are coupled proximate to a nose bridge portion of the artificial-reality glasses 100 and/or the first example rigid unibody member 104a. Force sensors 114 coupled proximate to the nose bridge portion of the artificial-reality glasses 100 and/or the first example rigid unibody member 104a allow for the capture of deformation data (e.g., because the nose bridge portion is likely to experience deformation during regular use). The force sensors 114 are configured to capture deformation data of the first example rigid unibody member 104a that can be used to apply (binocular) disparity correction. For example, the force sensors 114 can be used to determine whether the first lens assembly 108a and/or the second lens assembly 108b are not at their predefined positions (e.g., with respect to each other, the nose bridge portion, the deformable frame 102, and/or other portion of the artificial-reality glasses 100 and/or the first example rigid unibody member 104a). One or more force sensors 114 can be coupled to other locations (e.g., proximate to first lens assembly 108a and/or second lens assembly 108b of the artificial-reality glasses). The one or more force sensors 114 can include one or more strain gauges and/or other types of force sensors (e.g., piezoelectric strain sensors, etc.). The one or more force sensors can also be configured to measure strains, stresses, and/or other types of impact force related mechanically deformations.

Each display assembly includes a lens assembly 108 and a display projector assembly 118. For example, a first display assembly includes a first lens assembly 108a and a first display projector assembly 118a and a second display assembly includes a second lens assembly 108b and a second display projector assembly 118b. The first lens assembly 108a includes one or more waveguides configured to cause display of the artificial-reality environment. In some embodiments, the one or more waveguides include optical gratings for in-coupling light from the display projector assembly 118 and out-coupling light for causing display of the artificial-reality environment. The display projector assemblies 118 can include one or more display engines that are configured to display one or more images (e.g., one or more display engines coupled to the rigid unibody member). The display assemblies are configured to display visual representations of data to a user. In some embodiments, the first lens assembly 108a is coupled to a first portion of the first example rigid unibody member 104a and the second lens assembly 108b is coupled to a second portion of the first example rigid unibody member 104a (e.g., coupled to opposite ends of the first example rigid unibody member 104a). The first lens assembly 108a and the second lens assembly 108b have relative predefined positions with respect to each other. For example, the second lens assembly 108b coupled at the second portion of the first example rigid unibody member 104a is separated from the first lens assembly 108a (coupled at the first portion of the first example rigid unibody member 104a) by a predetermined distance (e.g., average eye separation). The first display projector assembly 118a is optically coupled (e.g., optically aligned) with the first lens assembly 108a and the second display projector assembly 118b is optically coupled (e.g., optically aligned) with the second lens assembly 108b such that each display assembly presents a respective visual representation of data.

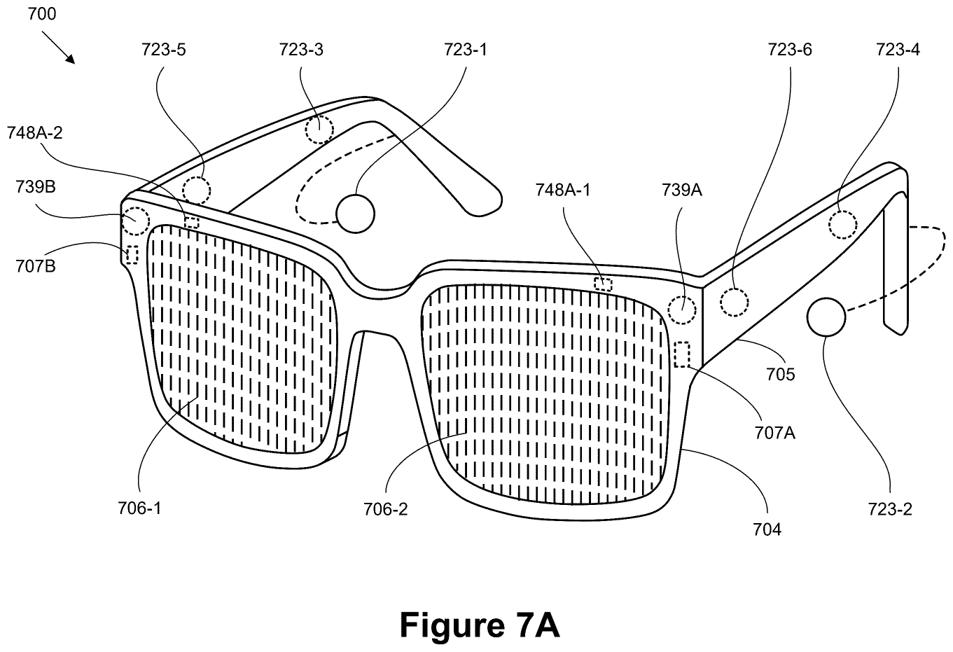

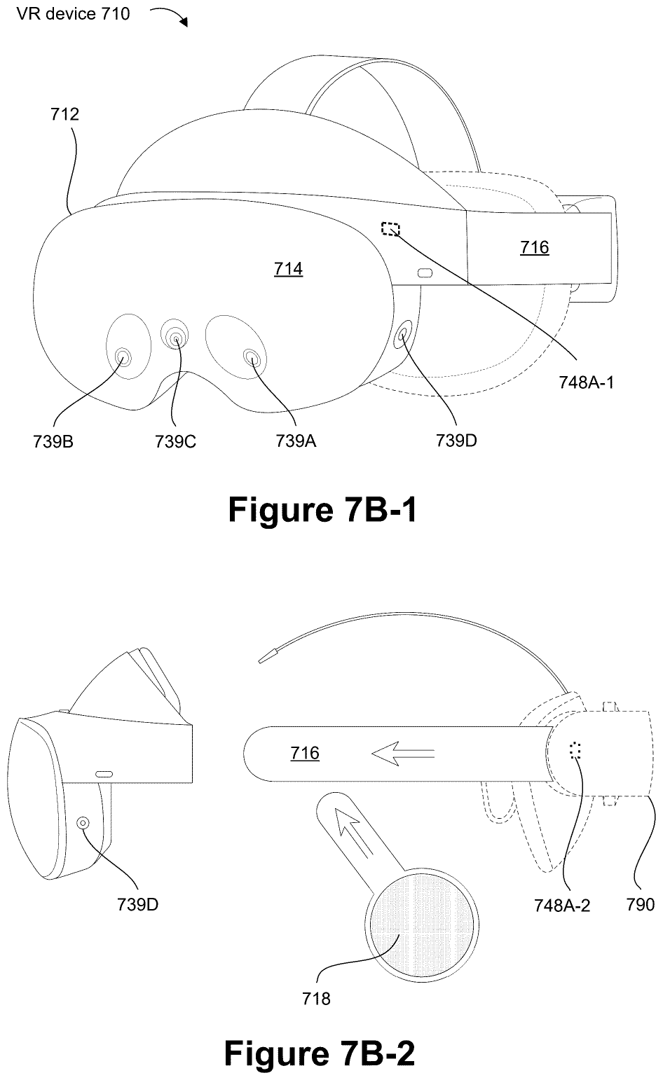

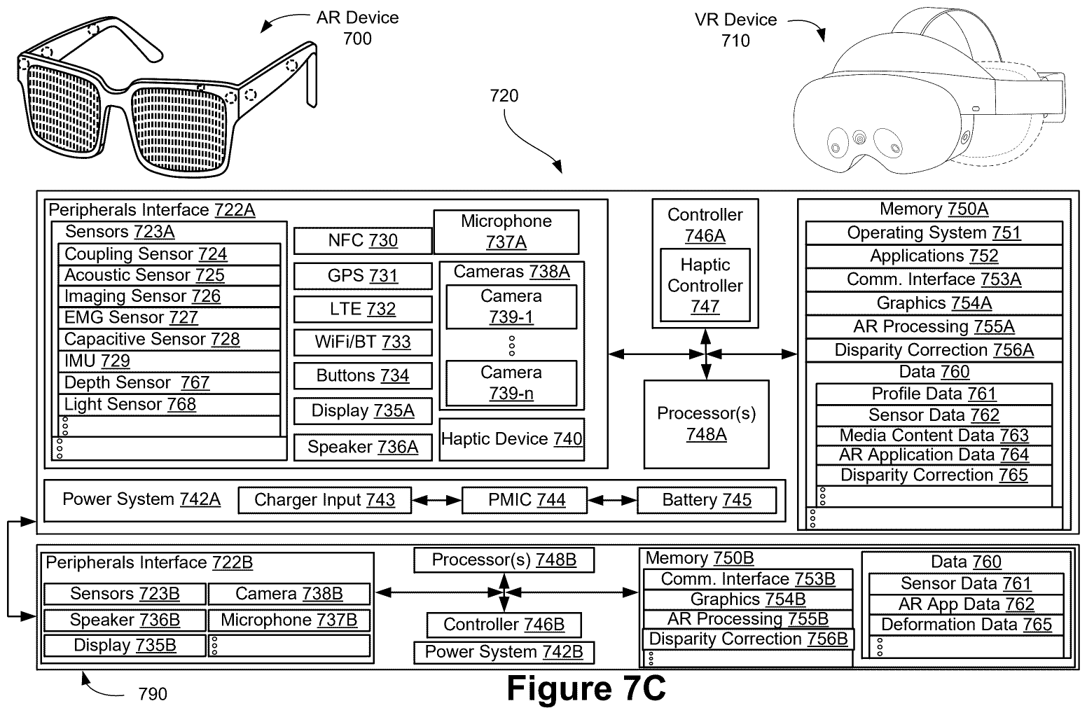

The display assemblies (or the first example rigid unibody member 104a) can further include one or more sensor assemblies 116 (e.g., including sensors 723 described below in reference to FIGS. 7A-7C) and/or one or more depth sensors 117 (point-of-view cameras) that are used to detect at least one disparity between the first and second display assemblies, the first and second lens assemblies, and/or the respective display assembly and lens assembly.

The sensor assemblies 116 and/or the depth sensors 117 are coupled and/or affixed to predetermined portions of the first example rigid unibody member 104a. Similar to the display projector assemblies 118, in some embodiments, the sensor assemblies 116 and/or the depth sensors 117 are coupled to opposite ends of the first example rigid unibody member 104a. By coupling the sensor assemblies 116 and/or the depth sensors 117 at predetermined locations on the rigid unibody member, data captured by the sensor assemblies 116 and/or the depth sensors 117 can be used to determine an alignment of the first lens assembly 108a and second lens assembly 108b and/or at least one binocular disparity between the first lens assembly 108a and second lens assembly 108b (and/or the visual representations of data presented using the first lens assembly 108a and second lens assembly 108b). For example, a misalignment between the between the first lens assembly 108a and the second lens assembly 108b can be used to determine at least one horizontal lens disparity and/or at least one vertical lens disparity.

Additionally or alternatively, by coupling the sensor assemblies 116 and/or the depth sensors 117 at predetermined locations on the rigid unibody member, data captured by the sensor assemblies 116 and/or the depth sensors 117 can be used to determine an alignment of the first display assembly 118a and second display assembly 118b and/or at least one binocular disparity between the first display assembly 118a and the second display assembly 118b (and/or the visual representations of data presented using the first display assembly 118a and second display assembly 118b). For example, a misalignment between the between the first display assembly 108a and the second display assembly 108b can be used to determine at least one horizontal display disparity and/or at least one vertical display disparity.

This is advantageous for disparity correction as the data captured by the sensor assemblies 116 and/or the depth sensors 117 can be used to correct the at least one horizontal and/or the at least one vertical disparity caused by deformation or warpage of the deformable frame 102. Specifically, while the first example rigid unibody member 104a is configured to reduce or eliminate disparity of the display assemblies and/or the lens assemblies, detected disparity (while the artificial-reality glasses 100 are in use) can be corrected using the data captured by the sensor assemblies 116 and/or the depth sensors 117. In some embodiments, when the first lens assembly 108a and the second lens assembly 108b are out of alignment, the data captured by the sensor assemblies 116 and/or the depth sensors 117 can be used for accurate disparity correction by automatically adjusting one or more optical components (e.g., lens, collimation optics, etc.) of the first and/or second display projector assembly. For example, a lens of the first or second display projector assembly is moved by a nominal amount (e.g., tens of micrometers, 1 mm, etc.) based on the sensor data and/or other calibration data, to correct for the optical disparity. As another example, when the first display assembly 118a and the second display assembly 118b are out of alignment, the data captured by the sensor assemblies 116 and/or the depth sensors 117 can be used for accurate disparity correction. As another example, when the first lens assembly 108a, the second lens assembly 108b, the first display assembly 118a, and/or the second display assembly 118b are out of alignment, the data captured by the sensor assemblies 116 and/or the depth sensors 117 can be used for accurate disparity correction by making adjustments to one or more display projector assembly components.

In some embodiments, if artificial-reality display content is world-locked, horizontal binocular disparity correction is necessary because horizontal disparity is associated with a user being able to accurately perceive depth information from two-dimensional images. However, if artificial-reality display content is user-locked, horizontal disparity correction requirements can be reduced and/or forgone and instead, vertical disparity correction requirements are emphasized. For example, the system prioritizes vertical disparity correction over horizontal disparity correction if the artificial-reality display content is to be user-locked. In some embodiments, vertical disparity correction is configured to be performed ahead of horizontal disparity correction if the user reports eye strain, headaches, and/or poor image quality.

FIG. 1B illustrate a second example of a rigid unibody member 104b included in the artificial-reality glasses 100. The second example rigid unibody member 104b includes analogous features to those described above in reference to the first example rigid unibody member 104a. The second example rigid unibody member 104b includes one or more foam adhesives 110 to decouple the display assemblies from the deformable frame 102. The foam adhesives 110 can be a foam pressure sensitive adhesive (or foam including a pressure sensitive adhesive for coupling the foam to the second example rigid unibody member 104b). The foam adhesives 110, like the flexures 112, contact portions of the deformable frame 102 to allow the second example of the rigid unibody member 104b to be distinct and separate from the deformable frame 102. The foam adhesives 110 are configured to reduce mechanical loads transferred from the deformable frame 102 to the second example rigid unibody member 104b, the display assemblies, and/or components thereof (e.g., reduce mechanical loads transferred from the deformable frame 102 when the deformable frame 102 experiences a destructive impact and/or user applied stress that changes a size of the artificial-reality glasses 100). In other words, the foam adhesives 110, like the flexures 112, can decouple, dampen or reduce force transfer from the deformable frame 102 to the second example rigid unibody member 104b, the display assemblies, and/or components thereof such that destructive impacts are not fully transmitted to the second example rigid unibody member 104b, the display assemblies, and/or components thereof. In some embodiments, the foam adhesives 110 are configured to reduce the mechanical loads transferred by a predetermined amount (e.g., at least 20%, 50%, 70%, 80%, 90%, etc.). As described above, the foam adhesives 110 can be used alone or in conjunction with the flexures 112.

FIG. 1C illustrates another view of a rigid unibody member 104 coupled with one or more display assemblies, in accordance with some embodiments. As discussed above, the rigid unibody member 104 includes structure reinforcements 106. The structure reinforcements 106 can be truss assembly, a frame assembly, ribs, a step, and/or other structure. The structure reinforcements 106 increases the rigidity of the rigid unibody member 104. The structure reinforcements 106 can be coupled with one or more frame mounts 120 for coupling the rigid unibody member 104 to the deformable frame 102. In some embodiments, the frame mounts 120 also provide additional rigidity to the rigid unibody member 104 (e.g., the frame mounts 120 can add additional thickness and/or be formed of a distinct material than the surround material of rigid unibody member 104 to further increase rigidity (e.g., magnesium, titanium, steel, etc.).

FIG. 1C further shows a position of one or more force sensors 114, depth sensors 117a and 117b, and/or sensor assembly 116a and 116b. As described above, the force sensors 114, the depth sensors 117, and/or the sensor assemblies 116 can capture data that is used for online disparity correction. In some embodiments, the sensor assemblies 116 can include eye tracking sensors to determine where the user is looking when the artificial-reality glasses 100 are donned. These other sensors can also include proximity sensors to determine when the user has donned the artificial-reality glasses 100 and/or where the user's eyes are located with respect to respective positions of the first lens assembly 108a and the second lens assembly 108b. In some embodiments, the rigid unibody member 104 includes a step around each eyepiece region of the optical bench that conforms with mounting and/or structural requirements of the display assemblies and/or the temple arms of the artificial reality glasses 100. The step around the eyepiece region improves the stiffness of the rigid unibody member 104 while also providing functional mounting space for the corresponding display assembly, temple arm, and/or other lens assembly component.

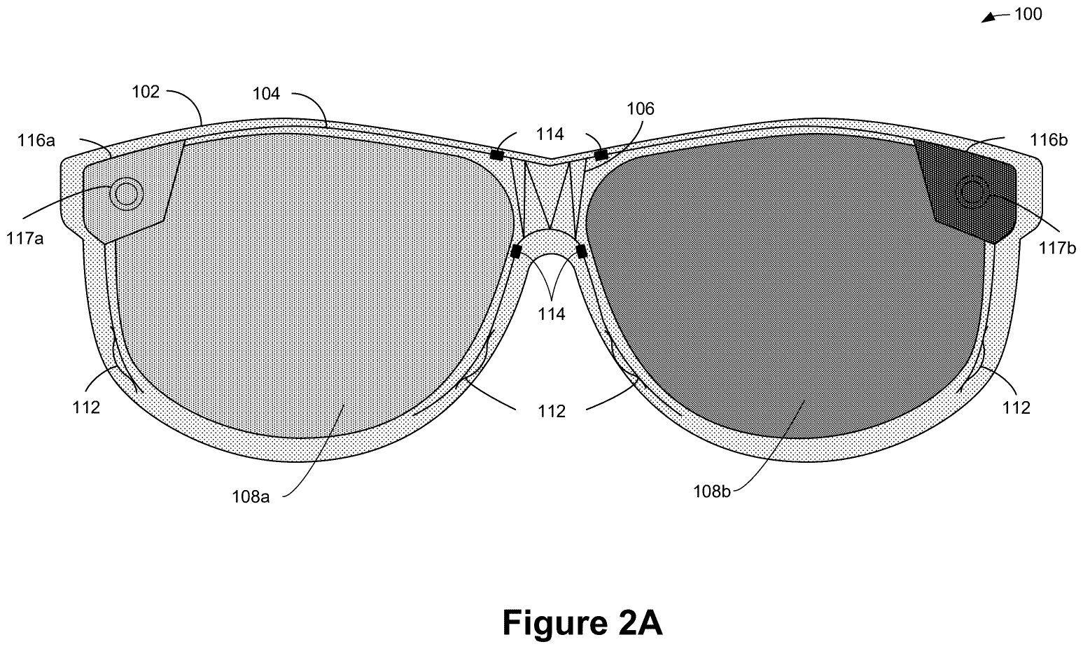

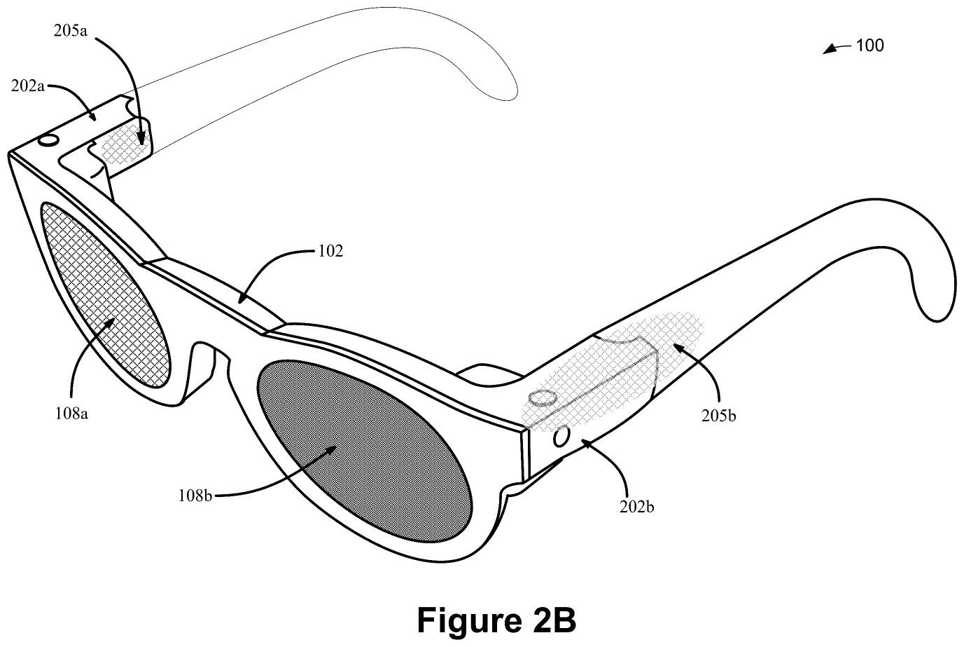

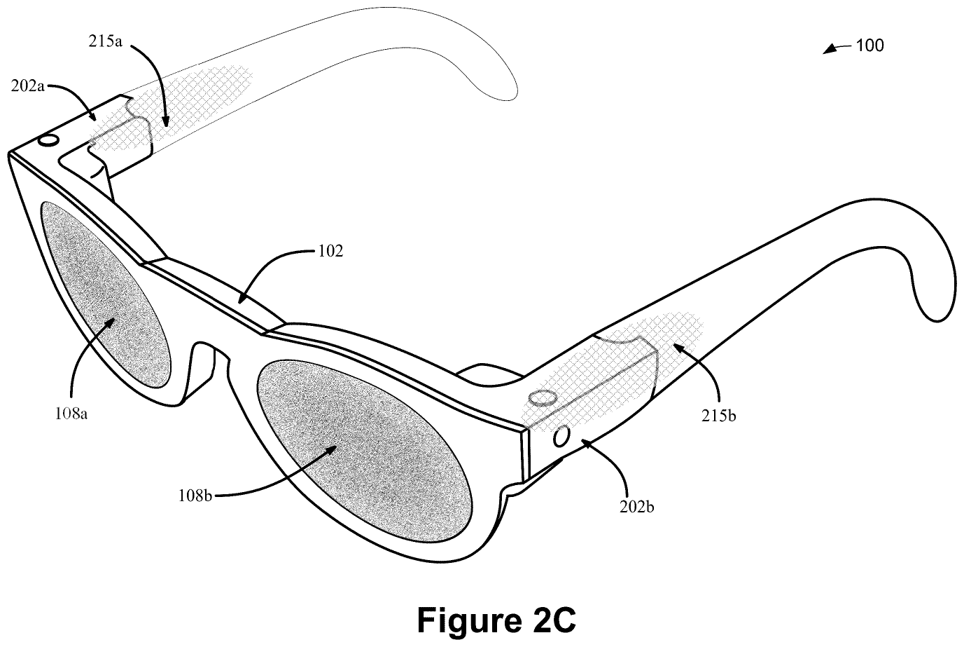

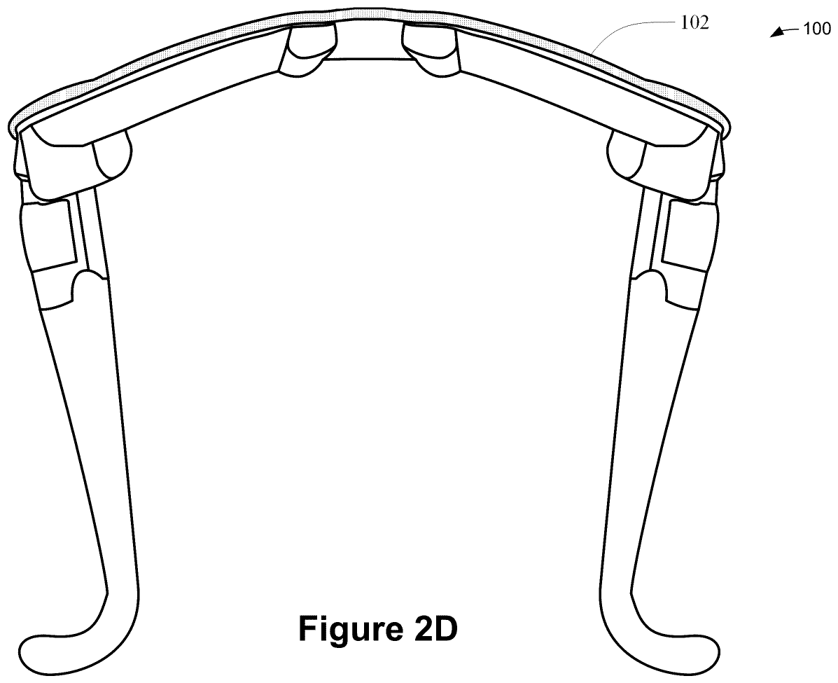

FIGS. 2A-2D illustrate an example of artificial-reality glasses in various thermal loading scenarios, in accordance with some embodiments.

FIG. 2A illustrates an example of artificial-reality glasses 100 when a second display assembly (the second lens assembly 108b and the second display projector assembly 118b), a second sensor assembly 116b, and/or a second depth sensor 117b are generating heat (e.g., due to one or more respective components being active). Additionally, as shown in FIG. 2A, the first display assembly (the first lens assembly 108a and the first display projector assembly 118a), a first sensor assembly 116a, and/or a first depth sensor 117a are not generating heat (e.g., due to one or more respective components being inactive or not significantly used). For example, when the second display assembly is generating heat, the second lens assembly 108b heats up (represented by dark shading). In contrast, the first lens assembly 108a is cooler that the second lens assembly 108b as the first display assembly is not generating as much heat (comparatively). The rigid unibody member 104, as described above, is configured to have a CTE substantially equal to coupled display assemblies to reduce or eliminate optical misalignment and/or warpage (e.g., arising from stress hot spots).

FIGS. 2B and 2C illustrate additional examples of artificial-reality glasses 100 under different thermal loading configurations. FIG. 2B shows thermal loads experienced by the artificial-reality glasses 100 when a single display assembly, a single sensor assembly 116b, and/or a single depth sensor 117b is generating heat (e.g., due to one or more respective components being active). As shown in FIG. 2B, the generated heat distribution (shaded region 205b) is concentrated at a single temple arm (e.g., second temple arm 202b). The other temple arm (e.g., 202a) remains at a lower temperature (as represented by a smaller heat distribution pattern of shaded region 205a) while the corresponding display assembly is functioning at a lower activity level. The disparity in the heat generated by the two display assemblies causes a disparity in the thermal loads experienced by the two lens assemblies 108a and 108b. For example, a higher thermal load experienced by the lens assembly 108b (darker shaded region) causes at least one misalignment between the lens assembly 108b and the display projector assembly 118b. The lower thermal load experienced by the lens assembly 108a (lighter shaded region) causes no misalignment or a lower magnitude of misalignment between the lens assembly 108a and the corresponding display projector assembly 118a.

FIG. 2C shows thermal loads experienced by the artificial-reality glasses 100 when two display assemblies, two sensor assemblies 116, and/or two depth sensors 117 are simultaneously generating comparable amounts of heat energy. As shown in FIG. 2C, generated heat can be concentrated at each of the temple arms (e.g., first and second temple arms 202a and 202b), in proximity to the display projector assemblies, as shown by the corresponding shaded regions 215a and 215b.

FIG. 2D illustrates an example of magnified deformation that can be experienced at the artificial-reality glasses 100 under heat soak. The deformations (resulting from thermal loads) cause the frame 102 of the artificial-reality glasses 100 to curve. Excessive curvature of the frame 102 of the artificial-reality glasses 100 results in misalignment of the lens assemblies 108 and the display projector assemblies 118. The rigid unibody member 104, when included in the artificial-reality glasses 100 reduces or eliminates the deformation of the artificial-reality glasses 100 when the artificial-reality glasses 100 is under thermal loads. In other words, the rigid unibody member 104 is configured to prevent or mitigate the deformation of the artificial-reality glasses 100 shown in FIG. 2D, as well as prevent or mitigate misalignment of the lens assemblies 108 and the display projector assemblies 118. Any misalignment that is not addressed by the rigid unibody member 104 can be corrected using the data captured by the sensor assemblies 116 and/or the depth sensors 117.

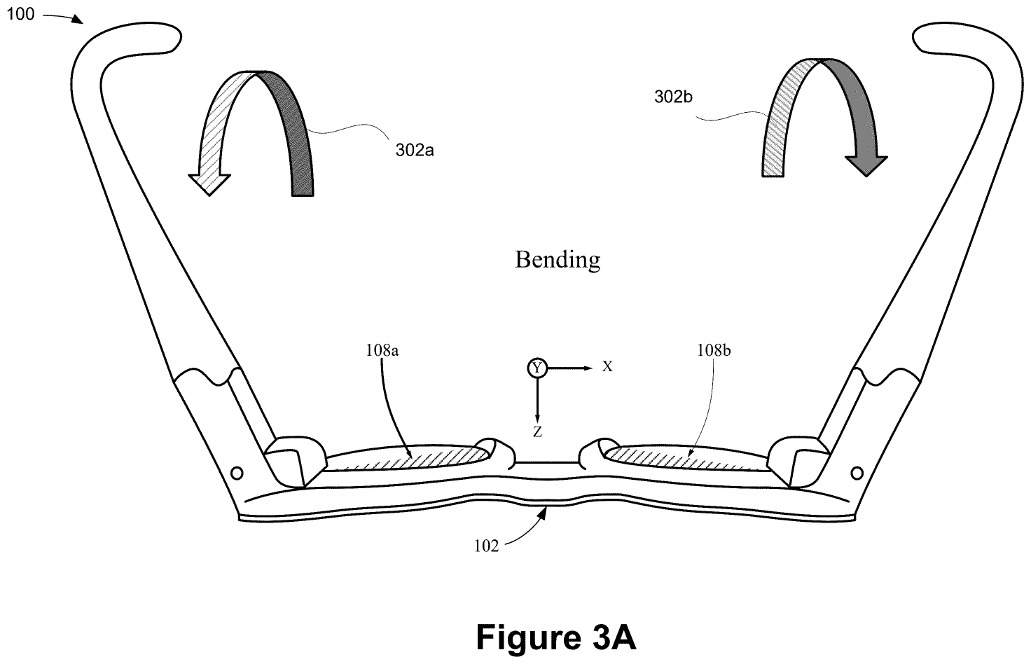

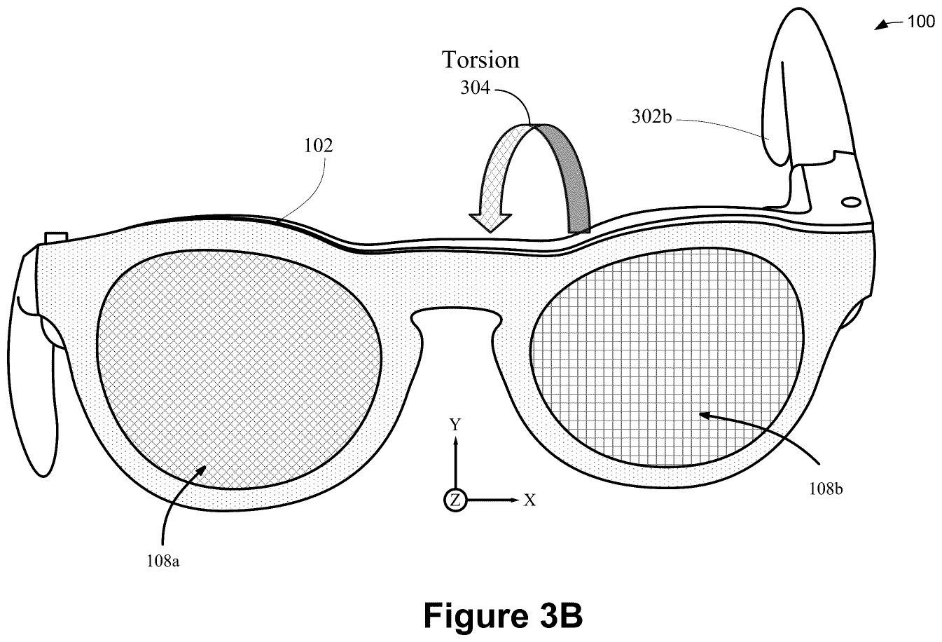

FIGS. 3A and 3B illustrate examples of mechanical loads that can be experienced by artificial-reality glasses, in accordance with some embodiments.

FIG. 3A illustrates an example of a bending load applied to the artificial-reality glasses 100. For example, a bending mechanical load can be applied to the artificial-reality glasses 100 when a user dons the artificial-reality glasses 100 and/or when the artificial-reality glasses 100 experience an impact force (e.g., a fall). As shown in FIG. 3A, the temple arms of artificial-reality glasses 100 are being pulled away from a center of the artificial-reality glasses 100. As a result, a position of the first lens assembly 108a and the second lens assembly 108b is changed (e.g., the displayed image at the lens assemblies are no longer parallel and directed to the user's eyes, but rather the displayed imaged is now directed towards a temple region of a user's head). This misalignment of the lens assemblies with the user's head can cause binocular disparity. In some embodiments, if a sufficient bending force 302a and 302b is applied to the artificial-reality glasses, it can be permanently deformed (which would require a user or manufacturer to correct the deformation).

FIG. 3B illustrates an example of torsion load applied to the artificial-reality glasses 100. A torsion mechanical loading can be applied when a user dons or doffs the artificial-reality glasses 100 with one hand and/or when the artificial-reality glasses 100 experience an impact force. As shown in FIG. 3B, a temple arm of the artificial-reality headset 100 is lifted upwards while the other arm is unsupported. As a result, a position of the first lens assembly 108a and the second lens assembly 108b is changed (e.g., the displayed image at the lens assemblies are now directed above and/or below at least one of the user's eyes). In other words, the artificial-reality glasses are now “crooked” and the centers of the lens assemblies are no longer at the centers of the user's eyes and/or the displayed images are not directed to the user's eyes. This misalignment of the lens assemblies with the user's head can cause binocular disparity. In some embodiments, if a sufficient torsion force 304 is applied to the artificial-reality glasses, it can be permanently deformed (which would require a user or manufacturer to correct the deformation).

The rigid unibody member 104, when included in the artificial-reality glasses 100 reduces or eliminates the deformation of the artificial-reality glasses 100 when the artificial-reality glasses 100 experiences the bending and/or torsion mechanical loads. In other words, the rigid unibody member 104 is configured to prevent or mitigate the deformation of the artificial-reality glasses 100 shown in FIGS. 3A and 3B, as well as prevent or mitigate misalignment of the lens assemblies 108 and the display projector assemblies 118. Any misalignment that is not prevented by the rigid unibody member 104 and/or the flexures 120 can be corrected using the data captured by the sensor assemblies 116 and/or the depth sensors 117.

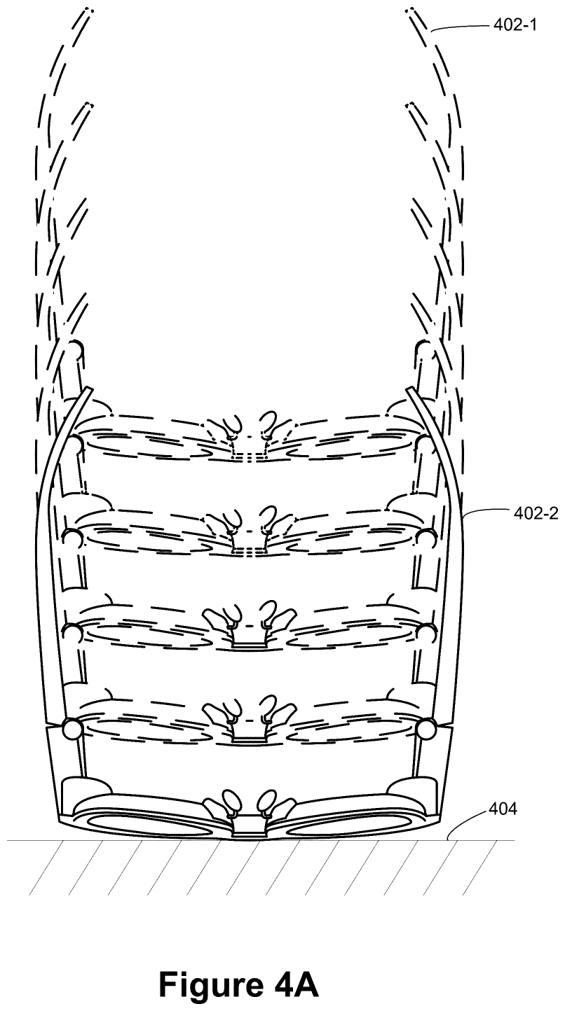

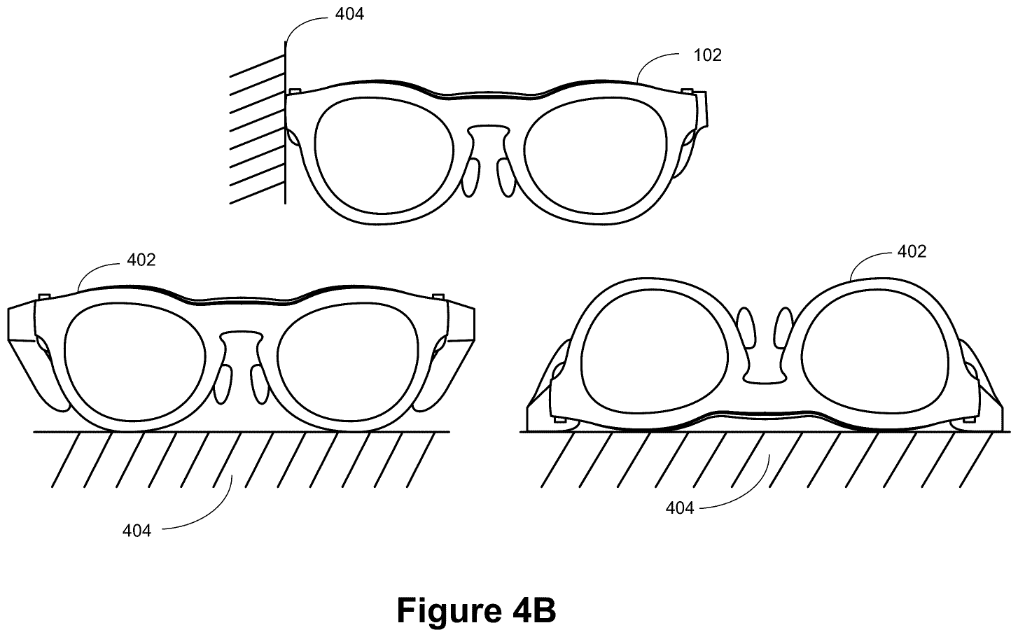

FIGS. 4A and 4B illustrate an impact force experienced by artificial-reality glasses, in accordance with some embodiments.

FIG. 4A illustrates the artificial-reality glasses 100 traveling from a starting position 402-1 to an ending position 402-2 (e.g., a surface contact position). In the example shown in FIG. 4A, the artificial-reality glasses 100 are dropped such that the front of the artificial-reality glasses 100 impacts the ground 404 first. The starting position 402-1 is at time t₁ and starts at an initial height, and the artificial-reality glasses 100 fall to the ground (e.g., a substantially zero height) at time t₂. An outside or exterior facing portion of the artificial-reality glasses 100 impacts the ground. When the artificial-reality glasses 100 impacts the ground, the deformable frame may warp; however, the rigid unibody member 104 (and components thereof described above in reference to FIGS. 1A-1C) reduces and/or eliminates any mechanical load transferred to the first and second display assemblies. In some embodiments, the rigid unibody member 104 (and components thereof described above in reference to FIGS. 1A-1C) reduces and/or eliminates mechanical load transfer to the first and second lens assemblies. The reduction in transferred mechanical load can reduce the disparity in the first and second display assemblies, if any. Permanent deformation caused by a drop can require a user or manufacturer to correct the deformation. As described above, any misalignment that is not prevented by the rigid unibody member 104 can be corrected using the data captured by the sensor assemblies 116 and/or the depth sensors 117.

FIG. 4B illustrates alternative impacts that can be experienced by the artificial-reality glasses 100. For example, the artificial-reality glasses 100 can be dropped on its sides, top, bottom, at an angle, etc. The rigid unibody member 104 (and components thereof described above in reference to FIGS. 1A-1C) reduces and/or eliminates any mechanical load transferred to the first and second display assemblies and/or the first and second lens assemblies as described above in reference to FIG. 4A.

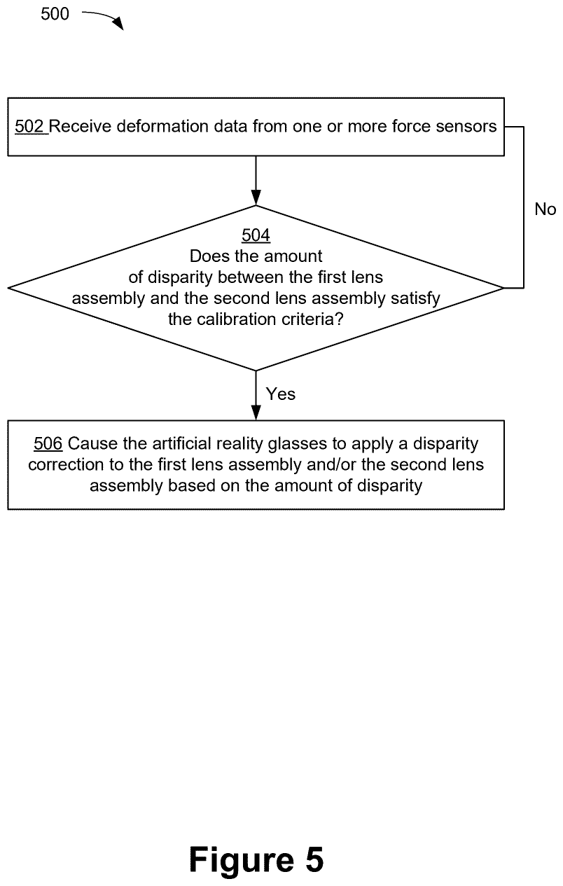

FIG. 5 shows an example method flow chart for correcting disparity at artificial-reality glasses, in accordance with some embodiments. Operations (e.g., steps) of the method 500 can be performed by one or more processors (e.g., central processing unit and/or MCU) of the artificial-reality glasses. At least some of the operations shown in FIG. 5 correspond to instructions stored in a computer memory or computer-readable storage medium (e.g., storage, RAM, and/or memory) of the artificial-reality glasses. Operations of the method 500 can be performed by a single device alone or in conjunction with one or more processors and/or hardware components of another communicatively coupled device (e.g., artificial-reality glasses) and/or instructions stored in memory or computer-readable medium of the other device communicatively coupled to the artificial-reality glasses. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

The example method of correcting disparity at the artificial-reality glasses comprises receiving (step 502, as shown in FIG. 5) deformation data from one or more force sensors. The method includes determining (504) whether the amount of disparity between a first lens assembly and a second lens assembly satisfies a calibration criteria. If the amount of disparity between a first lens assembly and a second lens assembly does not satisfy the calibration criteria (“No” at operation 504), the method 500 returns to step 502. Alternatively, if the amount of disparity between a first lens assembly and a second lens assembly does satisfy the calibration criteria (“Yes” at operation 504), the method 500 causes (506) the artificial-reality glasses to apply a disparity correction to the first lens assembly and/or the second lens assembly based on the amount of disparity.

(A1) Artificial-reality glasses (e.g., artificial-reality glasses 100 shown in FIGS. 1A-1C) includes a deformable frame 102, a rigid unibody member 104, a first lens assembly 108a, a second lens assembly 108b, one or more depth sensors 117, one or more force sensors 114, and one or more processors 748 (FIGS. 7A-7C). The rigid unibody member is distinct and separate from the deformable frame. The rigid unibody member includes a plurality of structure reinforcements (e.g., structure reinforcements 106 shown in FIG. 1A, ribs, steps, etc.). The plurality of structure reinforcements (e.g., a truss) can be at a nose bridge portion of the rigid unibody member. The structure reinforcements can increase the rigidity at the nose bridge portion of the rigid unibody member. The first lens assembly and/or the second lens assembly can include one or more waveguides, gratings, optical couplers, holographic optical elements, adhesives, optical coatings, light sources, substrates, mounting components, and virtual image distance (VID) lenses. The one or more display engines can include display projector assemblies 118 and sensor assemblies 116. The first lens assembly is coupled to a first portion of the rigid unibody member. The second lens assembly is coupled to a second portion of the rigid unibody member at a predefined relative position to the first lens assembly. The first display engine is coupled to the rigid unibody member near a first temple portion and is positioned at a predefined location relative to the first lens assembly. The second display engine is coupled to rigid unibody member near a second temple portion and is positioned at a predefined location relative to the second lens assembly.

The predefined relative positions of the first lens assembly and the second lens assembly are such that there is little to no unintended binocular disparity. For example, the first lens assembly and the second lens assembly are at the predefined relative position such that the intended disparity helps the user perceive depth in the virtual- or augmented-reality environment without unintended disparity from deformation of the artificial-reality glasses reducing image quality. The predefined relative positions of the first display engine and the second display engine with respect to their corresponding lens assemblies are such that there is little to no optical or angular misalignment. Minimizing optical and angular misalignments prevents unintended binocular disparity.

The one or more depth sensors (e.g., display and sensor assembly 116a and 116b shown in FIG. 1A) can be coupled and/or affixed to the rigid unibody member. In some embodiments, the one or more depth sensors can be coupled to the deformable frame.

The one or more force sensors are coupled and/or affixed to the rigid unibody member. The one or more force sensors are configured to detect deformation of the rigid unibody member such that the second lens assembly is not at the predefined position relative to the first lens assembly. In some embodiments, the one or more force sensors are configured to detect deformation of the rigid unibody member when the second display assembly is not at the predefined position relative to the first display assembly. At least one of the one or more force sensors are coupled proximate to the nose bridge portion of the rigid unibody member. The nose bridge portion of the rigid unibody member may be more sensitive to deformation. For example, if the rigid unibody member or the artificial-reality glasses are twisted or bent, the nose bridge portion of the rigid unibody member is likely to deform before other portions of the rigid unibody member or the artificial-reality glasses deform. In some embodiments, a rigid unibody member is decoupled from the rest of the artificial-reality glasses. One advantage of decoupling the rigid unibody member from the artificial-reality glasses is that it reduces the load transfer to the display module and thereby reducing the likelihood of binocular disparity caused by deformation associated with the display module.

In some embodiments, the one or more force sensors and/or the one or more depth sensors are affixed to and/or coupled with the rigid unibody member rather than an outer frame or the deformable frame of the artificial-reality glasses to provide sensor measurements that directly correlate with deformations in the display assemblies, the lens assemblies, and/or between the respective display assemblies and the lens assemblies without the need for extra sensors.

The one or more processors 748 (FIGS. 7A-7C) are coupled with the deformable frame of the artificial-reality glasses (e.g., artificial-reality glasses 100 shown in FIG. 1A). The one or more processors are configured to receive deformation data (e.g., the deformation of the artificial-reality glasses 100 shown in FIGS. 2D and 3A-3B) from the one or more force sensors. The one or more processors are further configured to, in accordance with a determination that an amount of disparity between the first lens assembly and the second lens assembly satisfies calibration criteria, cause the artificial-reality glasses to apply a disparity correction to the first lens assembly and the second lens assembly. The determination that the amount of disparity satisfies calibration criteria can be based on the deformation data. The disparity correction can be based on the amount of disparity arising from optical and/or mechanical sources of disparity (e.g., optical disparity, mechanical misalignment, mechanical deformation, etc.) between the first lens assembly and the second lens assembly.

In some embodiments, the one or more processors are further configured to, in accordance with a determination that an amount of disparity between the first display assembly and the second display assembly satisfies a second calibration criteria, cause the artificial-reality glasses to apply a second disparity correction to the first display assembly and the second display assembly. The determination that the amount of second disparity satisfies the second calibration criteria can be based on the deformation data. The disparity correction can be based on the amount of disparity between the first display assembly and the second display assembly.

(A2) In some embodiments of A1, the determination that the amount of disparity between the first lens assembly and the second lens assembly satisfies calibration criteria includes comparing deformation data from the one or more force sensors with a default amount of disparity between the first lens assembly and the second lens assembly (e.g., comparing the force detected by force sensors 114 in its current state to the predefined measurements at a default (e.g., resting) state). The default amount of disparity can be a baseline value that is set by the manufacturer. For example, after final assembly of the device, the force sensors can read zero force. In another example, after final assembly of the device, the force sensors can read a non-zero force and the non-zero force is set as the default amount of disparity (e.g., the force sensors are tared). In some embodiments, the force sensor is a strain gauge, a stress gauge, and/or other type of impact sensor configured to provide a quantitative measure of mechanical deformations, strains, and/or stresses present in the artificial-reality glasses 100.

(A3) In some embodiments of A1-A2, the one or more processors coupled with the deformable frame are further configured to receive depth information from the one or more depth sensors. The one or more processors are further configured to, in accordance with a determination that the amount of disparity between the first lens assembly and the second lens assembly satisfies calibration criteria, cause the artificial-reality glasses to apply the disparity correction to the first lens assembly and the second lens assembly. The determination that the amount of disparity satisfies calibration criteria can be based on the depth information. The disparity correction can be based on the amount of disparity.

(A4) In some embodiments of A1-A3, the artificial-reality glasses include one or more cameras (e.g., display and sensor assembly 116a and 116b shown in FIG. 1A) coupled to the rigid unibody member. The one or more cameras can be configured to capture one or more images. The one or more processors coupled with the deformable frame are further configured to receive the one or more images from the one or more cameras. In some embodiments, the amount of disparity is a first amount of disparity, and the disparity correction is a first disparity correction. In some embodiments, in accordance with a determination, based on the one or more images, that a second amount of disparity between the first lens assembly and the second lens assembly satisfies calibration criteria, cause the artificial-reality headset to apply a second disparity correction to the first lens assembly and the second lens assembly. The second disparity correction is based on the second amount of disparity.

In some embodiments, the one or more force sensors (e.g., one or more strain gauges) are coupled proximate to the nose bridge portion of the artificial-reality glasses (e.g., force sensors 114 coupled proximate to the nose bridge portion of the artificial-reality glasses 100 shown in FIG. 1A). In some embodiments, the artificial-reality glasses include an inertial measurement unit (IMU) to detect the artificial-reality glasses being picked up by a user (e.g., the user picking up the artificial-reality glasses to don and use). In response to detecting the glasses being picked up, one or more depth sensors and/or cameras are turned on for video capture (e.g., to capture a calibration video). In some embodiments, the one or more cameras include a point-of-view (POV) camera. For example, the POV camera is turned On in a low power and lower resolution mode to capture a calibration video as the user is donning the artificial-reality glasses to capture a pixel shift when mechanical stress is applied (e.g., when the artificial-reality glasses are too tight for a user's head and are deformed when worn) once the user dons the artificial-reality glasses. The POV camera can capture the distortion (e.g., pixel shift) of the captured calibration video when the artificial-reality glasses deform during donning. The artificial-reality glasses can determine the disparity between the first lens assembly and the second lens assembly based on the distortion (e.g., pixel shift). In some embodiments, the POV camera, once activated, is able to image the frame distortion while looking at a calibration target. For example, image data captured by the POV camera may capture the distortion due to frame warpage as it occurs, and the headset can correlate this back to the error in pixel disparity that will arise between the displays. The data from the IMU may be used to start capturing video as the user starts donning the device on their head in addition to strain gauge data across the nose bridge. The artificial-reality glasses can further receive data from the one or more force sensors (e.g., one or more strain gauges) to determine the deformation of the artificial-reality glasses. The one or more cameras and the one or more force sensors can be used separately or in combination. In some embodiments, the strain gauge and/or image data alone will be enough to correlate back to display disparity error. However, the combination can improve the accuracy of the determination of the deformation of the artificial-reality glasses.

(A5) In some embodiments of A4, the determination that the second amount of disparity between the first lens assembly and the second lens assembly satisfies calibration criteria includes determining a difference between a first image with a second image. The first image and the second image are captured from one or more cameras of the artificial-reality glasses. In some embodiments, the amount of disparity is further based on the difference between the first image and the second image. In some embodiments, the calibration criteria includes determining a difference between a first frame and a second frame of a plurality of frames associated with the calibration video. In some embodiments, the calibration criteria includes determining a pixel shift between one or more frames of the plurality of frames of the calibration video.

(A6) In some embodiments of A1-A5, the rigid unibody member includes a material with a coefficient of thermal expansion (CTE) less than a predefined thermal expansion threshold to reduce deformation of the rigid unibody member. For example, titanium may be used instead of aluminum because titanium has a lower CTE than aluminum.

(A7) In some embodiments of A1-A6, the rigid unibody member includes a material (e.g., the material of artificial-reality glasses 102 shown in FIGS. 2B and 2C) with a CTE within a predefined range relative to a coefficient of thermal expansion associated with the first lens assembly and the second lens assembly to reduce deformation. For example, the rigid unibody member, the first lens assembly, and the second lens assembly can have similar CTEs (e.g., the artificial-reality glasses 102-1 and 102-2, first lens assemblies 108a-1 and 108a-2, and second lens assemblies 108b-1 and 108b-2 shown in FIGS. 2B and 2C) such that when undergoing thermal change, the rigid unibody member expands and contracts at similar rates to the first lens assembly and the second lens assembly to reduce deformation.

(A8) In some embodiments of A1-A7, the rigid unibody member is coupled to the deformable frame at a nose bridge portion (e.g., via frame mounts 120 shown in FIG. 1A) of the rigid unibody member and a nose bridge portion (e.g., via frame mounts 120 shown in FIG. 1A) of the deformable frame to reduce mechanical loads transferred from the deformable frame to the rigid unibody member.

(A9) In some embodiments of A1-A8, the rigid unibody member is coupled to the deformable frame via one or more flexures (e.g., flexures 112 shown in FIG. 1A, screws, etc.) and/or one or more adhesives (e.g., foam adhesives 110 shown in FIG. 1B). In some embodiments, the one or more adhesives are fast-drying liquid adhesives with a high stiffness. The rigid unibody frame is coupled to deformable frame such that an amount of mechanical load (e.g., mechanical loads shown in FIGS. 3A and 3B, and/or mechanical loads associated with dropping artificial-reality glasses shown in FIGS. 4A and 4B) transferred is below a predefined threshold (e.g., reduction of mechanical loads transferred by at least 70%, 80%, 90%, etc.). The predefined threshold can be based on a maximum strain at the rigid unibody member without causing an amount of disparity between the first lens assembly and the second lens assembly that exceeds a predefined disparity threshold. In some embodiments, the flexures and/or the adhesives can reduce some deformations of the rigid bench from reaching the lens assembly, display engines, and/or waveguides. The adhesives can include foam pressure sensitive adhesives. The

(A10) In some embodiments of A1-A9, the rigid unibody member is coupled to the deformable frame such that an amount of mechanical loads are transferred from the deformable frame to the rigid unibody member is below a predefined threshold. The predefined threshold can be based on a maximum strain that the rigid unibody member can withstand without causing an amount of disparity between the first lens assembly and the second lens assembly that exceeds a predefined disparity threshold.

(A11) In some embodiments of A1-A10, the artificial-reality glasses further include one or more display engines and one or more waveguides. The one or more display engines are coupled to the rigid unibody member. The one or more waveguides are coupled to the rigid unibody member. In some embodiments, the rigid unibody member can maintain optical alignment and angular alignment of the one or more display engines to the corresponding one or more waveguides.

(B1) In accordance with some embodiments, a non-transitory computer readable storage medium includes instructions that, when executed by a computing device in communication with artificial-reality glasses, cause the computing device to perform any of (A1)-(A11).

(C1) In accordance with some embodiments, a method of assembly of artificial-reality glasses with disparity correction comprises forming a rigid unibody member, distinct and separate from a deformable frame, wherein: a nose bridge portion of the rigid unibody member includes a plurality of structure reinforcements; a first lens assembly coupled to a first portion of the rigid unibody member; a second lens assembly coupled to a second portion of the rigid unibody member at a predefined relative position to the first lens assembly; one or more depth sensors coupled to the rigid unibody member; and the one or more force sensors coupled to the rigid unibody member configured to detect deformation of the rigid unibody member such that the second lens assembly is not at the predefined relative position to the first lens assembly, wherein at least one of the one or more force sensors is coupled proximate to a nose bridge portion of the rigid unibody member.

(C2) In some embodiments, an amount of disparity between the first display assembly and the second display assembly satisfies a first calibration criteria, causing the artificial-reality glasses to apply a first disparity correction to the first display assembly and the second display assembly. The determination that the amount of second disparity satisfies the first calibration criteria can be based on the deformation data. The disparity correction can be based on the amount of disparity between the first display assembly and the second display assembly.

(C3) In some embodiments, the rigid unibody member further comprises any of A2-A11.

The devices described above are further detailed below, including systems. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a head-wearable device or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

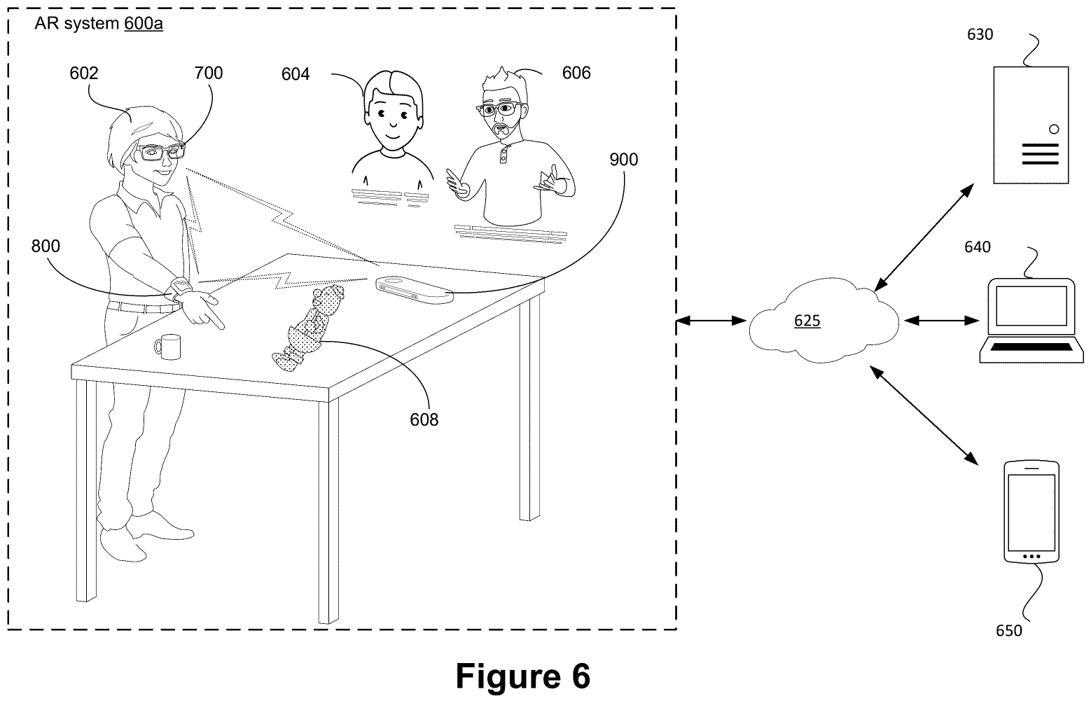

FIG. 6 illustrates example artificial-reality systems, in accordance with some embodiments. FIG. 6 shows a first AR system 600a and first example user interactions using a wrist-wearable device 800, a head-wearable device (e.g., AR device 700), and/or a handheld intermediary processing device (HIPD) 900. As the skilled artisan will appreciate upon reading the descriptions provided herein, the above-example AR systems (described in detail below) can perform various functions and/or operations described above with reference to FIGS. 1-5.

The head-wearable devices and their constituent components are described below in reference to FIGS. 7A-7C. The wrist-wearable device 800, the head-wearable devices, and/or the HIPD 900 can communicatively couple via a network 625 (e.g., cellular, near field, Wi-Fi, personal area network, wireless LAN, etc.). Additionally, the wrist-wearable device 800, the head-wearable devices, and/or the HIPD 900 can also communicatively couple with one or more servers 630, computers 640 (e.g., laptops, computers, etc.), mobile devices 650 (e.g., smartphones, tablets, etc.), and/or other electronic devices via the network 625 (e.g., cellular, near field, Wi-Fi, personal area network, wireless LAN, etc.)

In FIG. 6, a user 602 is shown wearing the wrist-wearable device 800 and the AR device 700, and having the HIPD 900 on their desk. The wrist-wearable device 800, the AR device 700, and the HIPD 900 facilitate user interaction with an AR environment. In particular, as shown by the first AR system 600a, the wrist-wearable device 800, the AR device 700, and/or the HIPD 900 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 800, the AR device 700, and/or the HIPD 900.

The user 602 can use any of the wrist-wearable device 800, the AR device 700, and/or the HIPD 900 to provide user inputs. For example, the user 602 can perform one or more hand gestures that are detected by the wrist-wearable device 800 (e.g., using one or more EMG sensors and/or IMUs) and/or AR device 700 (e.g., using one or more image sensors or cameras, described below in reference to FIGS. 7A-7B) to provide a user input. Alternatively, or additionally, the user 602 can provide a user input via one or more touch surfaces of the wrist-wearable device 800, the AR device 700, and/or the HIPD 900, and/or voice commands captured by a microphone of the wrist-wearable device 800, the AR device 700, and/or the HIPD 900. In some embodiments, the wrist-wearable device 800, the AR device 700, and/or the HIPD 900 include a digital assistant to help the user in providing a user input (e.g., completing a sequence of operations, suggesting different operations or commands, providing reminders, confirming a command). In some embodiments, the user 602 can provide a user input via one or more facial gestures and/or facial expressions. For example, cameras of the wrist-wearable device 800, the AR device 700, and/or the HIPD 900 can track the user 602's eyes for navigating a user interface.

The wrist-wearable device 800, the AR device 700, and/or the HIPD 900 can operate alone or in conjunction to allow the user 602 to interact with the AR environment. In some embodiments, the HIPD 900 is configured to operate as a central hub or control center for the wrist-wearable device 800, the AR device 700, and/or another communicatively coupled device. For example, the user 602 can provide an input to interact with the AR environment at any of the wrist-wearable device 800, the AR device 700, and/or the HIPD 900, and the HIPD 900 can identify one or more back-end and front-end tasks to cause the performance of the requested interaction and distribute instructions to cause the performance of the one or more back-end and front-end tasks at the wrist-wearable device 800, the AR device 700, and/or the HIPD 900. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). The HIPD 900 can perform the back-end tasks and provide the wrist-wearable device 800 and/or the AR device 700 operational data corresponding to the performed back-end tasks such that the wrist-wearable device 800 and/or the AR device 700 can perform the front-end tasks. In this way, the HIPD 900, which has more computational resources and greater thermal headroom than the wrist-wearable device 800 and/or the AR device 700, performs computationally intensive tasks and reduces the computer resource utilization and/or power usage of the wrist-wearable device 800 and/or the AR device 700.

In the example shown by the first AR system 600a, the HIPD 900 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 900 performs back-end tasks for processing and/or rendering image data (and other data) associated with the AR video call and provides operational data associated with the performed back-end tasks to the AR device 700 such that the AR device 700 performs front-end tasks for presenting the AR video call (e.g., presenting the avatar 604 and the digital representation of the contact 606).

In some embodiments, the HIPD 900 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 900. In particular, the HIPD 900 and the AR device 700 operate in conjunction to determine a location for presenting the avatar 604 and the digital representation of the contact 606. In some embodiments, information can be presented within a predetermined distance from the HIPD 900 (e.g., within five meters). For example, as shown in the first AR system 600a, virtual object 608 is presented on the desk some distance from the HIPD 900. Similar to the above example, the HIPD 900 and the AR device 700 can operate in conjunction to determine a location for presenting the virtual object 608. Alternatively, in some embodiments, presentation of information is not bound by the HIPD 900. More specifically, the avatar 604, the digital representation of the contact 606, and the virtual object 608 do not have to be presented within a predetermined distance of the HIPD 900.

User inputs provided at the wrist-wearable device 800, the AR device 700, and/or the HIPD 900 are coordinated such that the user can use any device to initiate, continue, and/or complete an operation. For example, the user 602 can provide a user input to the AR device 700 to cause the AR device 700 to present the virtual object 608 and, while the virtual object 608 is presented by the AR device 700, the user 602 can provide one or more hand gestures via the wrist-wearable device 800 to interact and/or manipulate the virtual object 608.

In some embodiments, the wrist-wearable device 800, the AR device 700, and/or the HIPD 900 are used to receive and/or provide one or more messages to a contact of the user 602. In particular, the wrist-wearable device 800, the AR device 700, and/or the HIPD 900 detect and coordinate one or more user inputs to initiate a messaging application and prepare a response to a received message via the messaging application.

In some embodiments, the user 602 initiates, via a user input, an application on the wrist-wearable device 800, the AR device 700, and/or the HIPD 900 that causes the application to initiate on at least one device. For example, the user 602 performs a hand gesture associated with a command for initiating a messaging application; the wrist-wearable device 800 detects the hand gesture; and, based on a determination that the user 602 is wearing AR device 700, causes the AR device 700 to present a messaging user interface of the messaging application. The AR device 700 can present the messaging user interface to the user 602 via its display. In some embodiments, the application is initiated and can be run on the device (e.g., the wrist-wearable device 800, the AR device 700, and/or the HIPD 900) that detects the user input to initiate the application, and the device provides another device operational data to cause the presentation of the messaging application. For example, the wrist-wearable device 800 can detect the user input to initiate a messaging application, initiate and run the messaging application, and provide operational data to the AR device 700 and/or the HIPD 900 to cause presentation of the messaging application. Alternatively, the application can be initiated and run at a device other than the device that detected the user input. For example, the wrist-wearable device 800 can detect the hand gesture associated with initiating the messaging application and cause the HIPD 900 to run the messaging application and coordinate the presentation of the messaging application.

Further, the user 602 can provide a user input provided at the wrist-wearable device 800, the AR device 700, and/or the HIPD 900 to continue and/or complete an operation initiated at another device. For example, after initiating the messaging application via the wrist-wearable device 800 and while the AR device 700 presents the messaging user interface, the user 602 can provide an input at the HIPD 900 to prepare a response (e.g., shown by the swipe gesture performed on the HIPD 900). The user 602's gestures performed on the HIPD 900 can be provided and/or displayed on another device. For example, the user 602's swipe gestures performed on the HIPD 900 are displayed on a virtual keyboard of the messaging user interface displayed by the AR device 700.

In some embodiments, the wrist-wearable device 800, the AR device 700, the HIPD 900, and/or other communicatively coupled devices can present one or more notifications to the user 602. The notification can be an indication of a new message, an incoming call, an application update, a status update, etc. The user 602 can select the notification via the wrist-wearable device 800, the AR device 700, or the HIPD 900 and cause presentation of an application or operation associated with the notification on at least one device. For example, the user 602 can receive a notification that a message was received at the wrist-wearable device 800, the AR device 700, the HIPD 900, and/or other communicatively coupled device and provide a user input at the wrist-wearable device 800, the AR device 700, and/or the HIPD 900 to review the notification, and the device detecting the user input can cause an application associated with the notification to be initiated and/or presented at the wrist-wearable device 800, the AR device 700, and/or the HIPD 900.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 700 can present to the user 602 game application data and the HIPD 900 can use a controller to provide inputs to the game. Similarly, the user 602 can use the wrist-wearable device 800 to initiate a camera of the AR device 700, and the user can use the wrist-wearable device 800, the AR device 700, and/or the HIPD 900 to manipulate the image capture (e.g., zoom in or out, apply filters, etc.) and capture image data.

In some embodiments, the user 602 can wear the wrist-wearable device 800 and a VR device 710, and holding the HIPD 900. For example, the wrist-wearable device 800, the VR device 710, and/or the HIPD 900 are used to interact within an AR environment, such as a VR game or other AR application. While the VR device 710 present a representation of a VR game (e.g., a first AR game environment) to the user 602, the wrist-wearable device 800, the VR device 710, and/or the HIPD 900 detect and coordinate one or more user inputs to allow the user 602 to interact with the VR game.

In some embodiments, the user 602 can provide a user input via the wrist-wearable device 800, the VR device 710, and/or the HIPD 900 that causes an action in a corresponding AR environment. For example, the user 602 can raise the HIPD 900 to prepare for a swing in the first AR game environment. The VR device 710, responsive to the user 602 raising the HIPD 900, causes the AR representation of the user to perform a similar action (e.g., raise a virtual object, such as a virtual sword). In some embodiments, each device uses respective sensor data and/or image data to detect the user input and provide an accurate representation of the user 602's motion. For example, image sensors (e.g., SLAM cameras or other cameras) of the HIPD 900 can be used to detect a position of the HIPD 900 relative to the user 602's body such that the virtual object can be positioned appropriately within the first AR game environment; sensor data from the wrist-wearable device 800 can be used to detect a velocity at which the user 602 raises the HIPD 900 such that the AR representation of the user and the virtual sword are synchronized with the user 602's movements; and image sensors 726 (FIGS. 7A-7C) of the VR device 710 can be used to represent the user 602's body, boundary conditions, or real-world objects within the first AR game environment 620.

In some embodiments, the user 602 performs a downward swing while holding the HIPD 900. The user 602's downward swing is detected by the wrist-wearable device 800, the VR device 710, and/or the HIPD 900 and a corresponding action is performed in the first AR game environment. In some embodiments, the data captured by each device is used to improve the user's experience within the AR environment. For example, sensor data of the wrist-wearable device 800 can be used to determine a speed and/or force at which the downward swing is performed and image sensors of the HIPD 900 and/or the VR device 710 can be used to determine a location of the swing and how it should be represented in the first AR game environment, which, in turn, can be used as inputs for the AR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

While the wrist-wearable device 800, the VR device 710, and/or the HIPD 900 are described as detecting user inputs, in some embodiments, user inputs are detected at a single device (with the single device being responsible for distributing signals to the other devices for performing the user input). For example, the HIPD 900 can operate an application for generating the first AR game environment and provide the VR device 710 with corresponding data for causing the presentation of the first AR game environment, as well as detect the 602's movements (while holding the HIPD 900) to cause the performance of corresponding actions within the first AR game environment. Additionally or alternatively, in some embodiments, operational data (e.g., sensor data, image data, application data, device data, and/or other data) of one or more devices is provide to a single device (e.g., the HIPD 900) to process the operational data and cause respective devices to perform an action associated with processed operational data.

Having discussed example AR systems, devices for interacting with such AR systems, such as the AR device 700 more generally, will now be discussed in greater detail below. Some definitions of devices and components that can be included in some or all of the example devices discussed below are defined here for case of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Head-Wearable Devices

FIGS. 7A-7C show example head-wearable devices, in accordance with some embodiments. Head-wearable devices can include, but are not limited to, AR devices 710 (e.g., AR or smart eyewear devices, such as smart glasses, smart monocles, smart contacts, etc.), VR devices 710 (e.g., VR headsets, head-mounted displays (HMD) s, etc.), or other ocularly coupled devices. The AR devices 700 and the VR devices 710 are instances of the head-wearable devices with a rigid unibody member as described in reference to FIGS. 1-5 herein, such that the head-wearable device should be understood to have the features of the AR devices 700 and/or the VR devices 710, and vice versa. The AR devices 700 and the VR devices 710 can perform various functions and/or operations associated with navigating through user interfaces and selectively opening applications, as well as the functions and/or operations described above with reference to FIGS. 1-5.

In some embodiments, an AR system (e.g., AR systems 600a; FIG. 6) includes an AR device 700 (as shown in FIG. 7A) and/or VR device 710 (as shown in FIGS. 7B-1-B-2). In some embodiments, the AR device 700 and the VR device 710 can include one or more analogous components (e.g., components for presenting interactive artificial-reality environments, such as processors, memory, and/or presentation devices, including one or more displays and/or one or more waveguides), some of which are described in more detail with respect to FIG. 7C. The head-wearable devices can use display projectors (e.g., display projector assemblies 707A and 707B) and/or waveguides for projecting representations of data to a user. Some embodiments of head-wearable devices do not include displays.

FIG. 7A shows an example visual depiction of the AR device 700 (e.g., which may also be described herein as augmented-reality glasses and/or smart glasses). The AR device 700 can work in conjunction with additional electronic components that are not shown in FIGS. 7A, such as a wearable accessory device and/or an intermediary processing device, in electronic communication or otherwise configured to be used in conjunction with the AR device 700. In some embodiments, the wearable accessory device and/or the intermediary processing device may be configured to couple with the AR device 700 via a coupling mechanism in electronic communication with a coupling sensor 724, where the coupling sensor 724 can detect when an electronic device becomes physically or electronically coupled with the AR device 700. In some embodiments, the AR device 700 can be configured to couple to a housing (e.g., a portion of frame 704 or temple arms 705), which may include one or more additional coupling mechanisms configured to couple with additional accessory devices. The components shown in FIG. 7A can be implemented in hardware, software, firmware, or a combination thereof, including one or more signal-processing components and/or application-specific integrated circuits (ASICs).

The AR device 700 includes mechanical glasses components, including a frame 704 configured to hold one or more lenses (e.g., one or both lenses 706-1 and 706-2). One of ordinary skill in the art will appreciate that the AR device 700 can include additional mechanical components, such as hinges configured to allow portions of the frame 704 of the AR device 700 to be folded and unfolded, a bridge configured to span the gap between the lenses 706-1 and 706-2 and rest on the user's nose, nose pads configured to rest on the bridge of the nose and provide support for the AR device 700, earpieces configured to rest on the user's ears and provide additional support for the AR device 700, temple arms 705 configured to extend from the hinges to the earpieces of the AR device 700, and the like. One of ordinary skill in the art will further appreciate that some examples of the AR device 700 can include none of the mechanical components described herein. For example, smart contact lenses configured to present artificial-reality to users may not include any components of the AR device 700.

The lenses 706-1 and 706-2 can be individual displays or display devices (e.g., a waveguide for projected representations). The lenses 706-1 and 706-2 may act together or independently to present an image or series of images to a user. In some embodiments, the lenses 706-1 and 706-2 can operate in conjunction with one or more display projector assemblies 707A and 707B to present image data to a user. While the AR device 700 includes two displays, embodiments of this disclosure may be implemented in AR devices with a single near-eye display (NED) or more than two NEDs.

The AR device 700 includes electronic components, many of which will be described in more detail below with respect to FIG. 7C. Some example electronic components are illustrated in FIG. 7A, including sensors 723-1, 723-2, 723-3, 723-4, 723-5, and 723-6, which can be distributed along a substantial portion of the frame 704 of the AR device 700. The different types of sensors are described below in reference to FIG. 7C. The AR device 700 also includes a left camera 739A and a right camera 739B, which are located on different sides of the frame 704. And the eyewear device includes one or more processors 748A and 748B (e.g., an integral microprocessor, such as an ASIC) that is embedded into a portion of the frame 704.

FIGS. 7B-1 and 7B-2 show an example visual depiction of the VR device 710 (e.g., a head-mounted display (HMD) 712, also referred to herein as an artificial-reality headset, a head-wearable device, a VR headset, etc.). The HMD 712 includes a front body 714 and a frame 716 (e.g., a strap or band) shaped to fit around a user's head. In some embodiments, the front body 714 and/or the frame 716 includes one or more electronic elements for facilitating presentation of and/or interactions with an AR and/or VR system (e.g., displays, processors (e.g., processor 748A-1), IMUs, tracking emitter or detectors, sensors, etc.). In some embodiments, the HMD 712 includes output audio transducers (e.g., an audio transducer 718-1), as shown in FIG. 7B-2. In some embodiments, one or more components, such as the output audio transducer(s) 718 and the frame 716, can be configured to attach and detach (e.g., are detachably attachable) to the HMD 712 (e.g., a portion or all of the frame 716, and/or the output audio transducer 718), as shown in FIG. 7B-2. In some embodiments, coupling a detachable component to the HMD 712 causes the detachable component to come into electronic communication with the HMD 712. The VR device 710 includes electronic components, many of which will be described in more detail below with respect to FIG. 7C

FIG. 7B-1 to 7B-2 also show that the VR device 710 one or more cameras, such as the left camera 739A and the right camera 739B, which can be analogous to the left and right cameras on the frame 704 of the AR device 700. In some embodiments, the VR device 710 includes one or more additional cameras (e.g., cameras 739C and 739D), which can be configured to augment image data obtained by the cameras 739A and 739B by providing more information. For example, the camera 739C can be used to supply color information that is not discerned by cameras 739A and 739B. In some embodiments, one or more of the cameras 739A to 739D can include an optional IR cut filter configured to remove IR light from being received at the respective camera sensors.

The VR device 710 can include a housing 790 storing one or more components of the VR device 710 and/or additional components of the VR device 710. The housing 790 can be a modular electronic device configured to couple with the VR device 710 (or an AR device 700) and supplement and/or extend the capabilities of the VR device 710 (or an AR device 700). For example, the housing 790 can include additional sensors, cameras, power sources, processors (e.g., processor 748A-2), etc. to improve and/or increase the functionality of the VR device 710. Examples of the different components included in the housing 790 are described below in reference to FIG. 7C.

Alternatively or in addition, in some embodiments, the head-wearable device, such as the VR device 710 and/or the AR device 700), includes, or is communicatively coupled to, another external device (e.g., a paired device), such as an HIPD 900 and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 900, an optional neckband, and/or wearable accessory device) with the head-wearable devices (e.g., an AR device 700 and/or VR device 710) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 900) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 900, can process information generated by one or more sensors of its sensors and/or information provided by other communicatively coupled devices. For example, a head-wearable device can include an IMU, and the intermediary processing device (neckband and/or an HIPD 900) can compute all inertial and spatial calculations from the IMUs located on the head-wearable device.

Artificial-reality systems may include a variety of types of visual feedback mechanisms. For example, display devices in the AR devices 700 and/or the VR devices 710 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 700 and/or the VR device 710 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 700 and the VR device 710, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 700 and/or the VR device 710 can include haptic feedback systems. The haptic feedback systems may provide various types of cutaneous feedback, including vibration, strain, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 800, an HIPD 900, smart textile-based garment, etc.), and/or other devices described herein.

FIG. 7C illustrates a computing system 720 and an optional housing 790, each of which show components that can be included in a head-wearable device (e.g., the AR device 700 and/or the VR device 710). In some embodiments, more or less components can be included in the optional housing 790 depending on practical restraints of the respective head-wearable device being described. Additionally or alternatively, the optional housing 790 can include additional components to expand and/or augment the functionality of a head-wearable device.

In some embodiments, the computing system 720 and/or the optional housing 790 can include one or more peripheral interfaces 722A and 722B, one or more power systems 742A and 742B (including charger input 743, PMIC 744, and battery 745), one or more controllers 746A 746B (including one or more haptic controllers 747), one or more processors 748A and 748B (as defined above, including any of the examples provided), and memory 750A and 750B, which can all be in electronic communication with each other. For example, the one or more processors 748A and/or 748B can be configured to execute instructions stored in the memory 750A and/or 750B, which can cause a controller of the one or more controllers 746A and/or 746B to cause operations to be performed at one or more peripheral devices of the peripherals interfaces 722A and/or 722B. In some embodiments, each operation described can occur based on electrical power provided by the power system 742A and/or 742B.

In some embodiments, the peripherals interface 722A can include one or more devices configured to be part of the computing system 720. For example, the peripherals interface can include one or more sensors 723A. Some example sensors include: one or more coupling sensors 724, one or more acoustic sensors 725, one or more imaging sensors 726, one or more EMG sensors 727, one or more capacitive sensors 728, and/or one or more IMUs 729. In some embodiments, the sensors 723A further include depth sensors 767, light sensors 768 and/or any other types of sensors defined above or described with respect to any other embodiments discussed herein.

In some embodiments, the peripherals interface can include one or more additional peripheral devices, including one or more NFC devices 730, one or more GPS devices 731, one or more LTE devices 732, one or more WiFi and/or Bluetooth devices 733, one or more buttons 734 (e.g., including buttons that are slidable or otherwise adjustable), one or more displays 735A, one or more speakers 736A, one or more microphones 737A, one or more cameras 738A (e.g., including the a first camera 739-1 through nth camera 739-n, which are analogous to the left camera 739A and/or the right camera 739B), one or more haptic devices 740; and/or any other types of peripheral devices defined above or described with respect to any other embodiments discussed herein.

The head-wearable devices can include a variety of types of visual feedback mechanisms (e.g., presentation devices). For example, display devices in the AR device 700 and/or the VR device 710 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 735A can be coupled to each of the lenses 706-1 and 706-2 of the AR device 700. The displays 735A coupled to each of the lenses 706-1 and 706-2 can act together or independently to present an image or series of images to a user. In some embodiments, the AR device 700 and/or the VR device 710 includes a single display 735A (e.g., a near-eye display) or more than two displays 735A.

In some embodiments, a first set of one or more displays 735A can be used to present an augmented-reality environment, and a second set of one or more display devices 735A can be used to present a virtual-reality environment. In some embodiments, one or more waveguides are used in conjunction with presenting artificial-reality content to the user of the AR device 700 and/or the VR device 710 (e.g., as a means of delivering light from a display projector assembly and/or one or more displays 735A to the user's eyes). In some embodiments, one or more waveguides are fully or partially integrated into the AR device 700 and/or the VR device 710. Additionally, or alternatively to display screens, some artificial-reality systems include one or more projection systems. For example, display devices in the AR device 700 and/or the VR device 710 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 735A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 735A for presenting information to users. For example, an external display 735A can be used to show a current battery level, network activity (e.g., connected, disconnected, etc.), current activity (e.g., playing a game, in a call, in a meeting, watching a movie, etc.), and/or other relevant information. In some embodiments, the external displays 735A can be used to communicate with others. For example, a user of the head-wearable device can cause the external displays 735A to present a do not disturb notification. The external displays 735A can also be used by the user to share any information captured by the one or more components of the peripherals interface 722A and/or generated by head-wearable device (e.g., during operation and/or performance of one or more applications).

The memory 750A can include instructions and/or data executable by one or more processors 748A (and/or processors 748B of the housing 790) and/or a memory controller of the one or more controllers 746A (and/or controller 746B of the housing 790). The memory 750A can include one or more operating systems 751; one or more applications 752; one or more communication interface modules 753A; one or more graphics modules 754A; one or more AR processing modules 755A; one or more disparity correction modules 756A for correcting disparity of the artificial-reality glasses; and/or any other types of modules or components defined above or described with respect to any other embodiments discussed herein.

The data 760 stored in memory 750A can be used in conjunction with one or more of the applications and/or programs discussed above. The data 760 can include profile data 761; sensor data 762; media content data 763; AR application data 764; deformation data 765 captured by the one or more force sensors or the one or more depth sensors for correcting disparity of the artificial-reality glasses; and/or any other types of data defined above or described with respect to any other embodiments discussed herein.

In some embodiments, the controller 746A of the head-wearable devices processes information generated by the sensors 723A on the head-wearable devices and/or another component of the head-wearable devices and/or communicatively coupled with the head-wearable devices (e.g., components of the housing 790, such as components of peripherals interface 722B). For example, the controller 746A can process information from the acoustic sensors 725 and/or image sensors 726. For each detected sound, the controller 746A can perform a direction of arrival (DOA) estimation to estimate a direction from which the detected sound arrived at a head-wearable device. As one or more of the acoustic sensors 725 detects sounds, the controller 746A can populate an audio data set with the information (e.g., represented by sensor data 762).

In some embodiments, a physical electronic connector can convey information between the head-wearable devices and another electronic device, and/or between one or more processors 748A of the head-wearable devices and the controller 746A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 900) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 700 and/or the VR device 710 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 7B-1 and 7B-2 show the VR device 710 having cameras 739A-739D, which can be used to provide depth information for creating a voxel field and a two-dimensional mesh to provide object information to the user to avoid collisions.

The optional housing 790 can include analogous components to those describe above with respect to the computing system 720. For example, the optional housing 790 can include a respective peripheral interface 722B including more or less components to those described above with respect to the peripherals interface 722A. As described above, the components of the optional housing 790 can be used augment and/or expand on the functionality of the head-wearable devices. For example, the optional housing 790 can include respective sensors 723B, speakers 736B, displays 735B, microphones 737B, cameras 738B, and/or other components to capture and/or present data. Similarly, the optional housing 790 can include one or more processors 748B, controllers 746B, and/or memory 750B (including respective communication interface modules 753B; one or more graphics modules 754B; one or more AR processing modules 755B, one or more disparity correction modules 756B, etc.) that can be used individually and/or in conjunction with the components of the computing system 720.

The techniques described above in FIGS. 7A-7C can be used with different head-wearable devices. In some embodiments, the head-wearable devices (e.g., the AR device 700 and/or the VR device 710) can be used in conjunction with one or more wearable device such as a wrist-wearable device 800 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. Artificial-reality glasses comprising:
a deformable frame;
a rigid unibody member, distinct and separate from the deformable frame, configured to couple to the deformable frame, wherein a nose bridge portion of the rigid unibody member includes a plurality of structure reinforcements;
a first lens assembly coupled to a first portion of the rigid unibody member;
a second lens assembly coupled to a second portion of the rigid unibody member at a predefined relative position to the first lens assembly;
one or more depth sensors coupled to the rigid unibody member;
one or more force sensors coupled to the rigid unibody member configured to detect deformation of the rigid unibody member such that the second lens assembly is not at the predefined relative position to the first lens assembly, wherein at least one of the one or more force sensors is coupled proximate to a nose bridge portion of the rigid unibody member; and
one or more processors coupled with the deformable frame configured to:
receive deformation data from the one or more force sensors; and
in accordance with a determination, based on the deformation data, that an amount of disparity between the first lens assembly and the second lens assembly satisfies calibration criteria:
cause the artificial-reality glasses to apply, based on the amount of disparity, a disparity correction to the first lens assembly and the second lens assembly.

2. The artificial-reality glasses of claim 1, wherein the determination that the amount of disparity between the first lens assembly and the second lens assembly satisfies the calibration criteria, includes:
comparing deformation data from the one or more force sensors with a default amount of disparity between the first lens assembly and the second lens assembly.

3. The artificial-reality glasses of claim 1, wherein the one or more processors coupled with the deformable frame are further configured to:
receive depth information from the one or more depth sensors; and
in accordance with a determination, based on the depth information, that the amount of disparity between the first lens assembly and the second lens assembly satisfies the calibration criteria:
cause the artificial-reality glasses to apply, based on the amount of disparity, the disparity correction to the first lens assembly and the second lens assembly.

4. The artificial-reality glasses of claim 1, wherein the amount of disparity is a first amount of disparity, the disparity correction is a first disparity correction, and the artificial-reality glasses including:
one or more cameras coupled to the rigid unibody member configured to capture one or more images; and
wherein the one or more processors coupled with the deformable frame are further configured to:
receive the one or more images from the one or more cameras; and
in accordance with a determination, based on the one or more images, that a second amount of disparity between the first lens assembly and the second lens assembly satisfies the calibration criteria:
cause the artificial-reality glasses to apply, based on the second amount of disparity, a second disparity correction to the first lens assembly and the second lens assembly.

5. The artificial-reality glasses of claim 4, wherein the determination that the second amount of disparity between the first lens assembly and the second lens assembly satisfies the calibration criteria, includes:
determining a difference between a first image of the one or more images from the one or more cameras with a second image of the one or more images from the one or more cameras; and
wherein the second amount of disparity is based on the difference between the first image of the one or more images and the second image of the one or more images.

6. The artificial-reality glasses of claim 1, wherein the rigid unibody member includes a material with a coefficient of thermal expansion less than a predefined thermal expansion threshold to reduce deformation of the rigid unibody member.

7. The artificial-reality glasses of claim 1, wherein the rigid unibody member includes a material with a coefficient of thermal expansion within a predefined range relative to a coefficient of thermal expansion associated with the first lens assembly and the second lens assembly to reduce deformation of the rigid unibody member.

8. The artificial-reality glasses of claim 1, wherein the rigid unibody member is coupled to the deformable frame at the nose bridge portion of the rigid unibody member and a nose bridge portion of the deformable frame to reduce mechanical loads transferred from the deformable frame to the rigid unibody member.

9. The artificial-reality glasses of claim 1, wherein the rigid unibody member is coupled to the deformable frame via one or more flexures or one or more adhesives such that an amount of mechanical loads transferred is below a predefined threshold.

10. The artificial-reality glasses of claim 1, wherein the rigid unibody member is coupled to the deformable frame such that an amount of mechanical loads transferred from the deformable frame to the rigid unibody member is below a predefined threshold.

11. The artificial-reality glasses of claim 1, including:
one or more display engines coupled to the rigid unibody member; and
one or more waveguides coupled to the rigid unibody member to maintain alignment of the one or more display engines to the one or more waveguides.

12. A non-transitory computer readable storage medium including instructions that, when executed by a computing device in communication with artificial-reality glasses, cause the computing device to:
receive deformation data from one or more force sensors; and
in accordance with a determination, based on the deformation data, that an amount of disparity between a first lens assembly and a second lens assembly of the artificial-reality glasses satisfies calibration criteria, apply, based on an amount of disparity, a disparity correction to the first lens assembly and the second lens assembly, wherein the artificial-reality glasses comprise:
a deformable frame;
a rigid unibody member, distinct and separate from the deformable frame, configured to couple to the deformable frame, wherein a nose bridge portion of the rigid unibody member includes a plurality of structure reinforcements;
the first lens assembly coupled to a first portion of the rigid unibody member;
the second lens assembly coupled to a second portion of the rigid unibody member at a predefined relative position to the first lens assembly;
one or more depth sensors coupled to the rigid unibody member; and
the one or more force sensors coupled to the rigid unibody member configured to detect deformation of the rigid unibody member such that the second lens assembly is not at the predefined relative position to the first lens assembly, wherein at least one of the one or more force sensors is coupled proximate to a nose bridge portion of the rigid unibody member.

13. The non-transitory computer readable storage medium of claim 12, wherein the determination that the amount of disparity between the first lens assembly and the second lens assembly satisfies the calibration criteria, includes:
comparing deformation data from the one or more force sensors with a default amount of disparity between the first lens assembly and the second lens assembly.

14. The non-transitory computer readable storage medium of claim 12, further including instructions that cause the computing device to:
receive depth information from the one or more depth sensors; and
in accordance with a determination, based on the depth information, that the amount of disparity between the first lens assembly and the second lens assembly satisfies the calibration criteria:
cause the artificial-reality glasses to apply, based on the amount of disparity, the disparity correction to the first lens assembly and the second lens assembly.

15. The non-transitory computer readable storage medium of claim 12, wherein the amount of disparity is a first amount of disparity, the disparity correction is a first disparity correction, and the artificial-reality glasses include one or more cameras coupled to the rigid unibody member to capture one or more images, and further storing instructions that cause the computing device:
receive the one or more images from the one or more cameras; and
in accordance with a determination, based on the one or more images, that a second amount of disparity between the first lens assembly and the second lens assembly satisfies the calibration criteria, cause the artificial-reality glasses to apply, based on the second amount of disparity, a second disparity correction to the first lens assembly and the second lens assembly.

16. The non-transitory computer readable storage medium of claim 15, wherein the determination that the second amount of disparity between the first lens assembly and the second lens assembly satisfies the calibration criteria, includes:
determining a difference between a first image of the one or more images from the one or more cameras with a second image of the one or more images from the one or more cameras, wherein the second amount of disparity is based on the difference between the first image of the one or more images and the second image of the one or more images.

17. A method of correcting disparity at artificial-reality glasses, comprising:
receiving deformation data from one or more force sensors; and
in accordance with a determination, based on the deformation data, that an amount of disparity between a first lens assembly and a second lens assembly of the artificial-reality glasses satisfies calibration criteria, applying, based on an amount of disparity, a disparity correction to the first lens assembly and the second lens assembly, wherein the artificial-reality glasses comprise:
a deformable frame;
a rigid unibody member, distinct and separate from the deformable frame, configured to couple to the deformable frame, wherein a nose bridge portion of the rigid unibody member includes a plurality of structure reinforcements;
the first lens assembly coupled to a first portion of the rigid unibody member;
the second lens assembly coupled to a second portion of the rigid unibody member at a predefined relative position to the first lens assembly;
one or more depth sensors coupled to the rigid unibody member; and
the one or more force sensors coupled to the rigid unibody member configured to detect deformation of the rigid unibody member such that the second lens assembly is not at the predefined relative position to the first lens assembly, wherein at least one of the one or more force sensors is coupled proximate to a nose bridge portion of the rigid unibody member.

18. The method of claim 17, wherein the determining that the amount of disparity between the first lens assembly and the second lens assembly satisfies the calibration criteria, includes:
comparing deformation data from the one or more force sensors with a default amount of disparity between the first lens assembly and the second lens assembly.

19. The method of claim 17, further comprising:
receiving depth information from the one or more depth sensors; and
in accordance with a determination, based on the depth information, that the amount of disparity between the first lens assembly and the second lens assembly satisfies the calibration criteria:
causing the artificial-reality glasses to apply, based on the amount of disparity, the disparity correction to the first lens assembly and the second lens assembly.

20. The method of claim 17, wherein the amount of disparity is a first amount of disparity, the disparity correction is a first disparity correction, and the artificial-reality glasses include one or more cameras coupled to the rigid unibody member to capture one or more images, the method further comprising:
receiving the one or more images from the one or more cameras; and
in accordance with a determination, based on the one or more images, that a second amount of disparity between the first lens assembly and the second lens assembly satisfies the calibration criteria, causing the artificial-reality glasses to apply, based on the second amount of disparity, a second disparity correction to the first lens assembly and the second lens assembly.
